(19) United States
(12) Patent Application Publication
(10) Pub. No.: US 2026/0179609 A1
(43) Pub. Date: Jun. 25, 2026

(54) SYSTEMS AND METHODS FOR INTERACTIVELY IMPROVING THE EFFICIENCY AND NATURALNESS OF VOICE COMMANDS

(71) Applicant: Adeia Guides Inc., San Jose, CA (US)

(72) Inventors: Aldis Sipolins, Somerville, MA (US); Ning Xu, Irvine, CA (US); Tao Chen, Palo Alto, CA (US)

(21) Appl. No.: 18/987,338

(22) Filed: Dec. 19, 2024

(51) Int. Cl. G10L 15/187; G10L 15/02; G10L 15/22

(52) U.S. Cl. CPC G10L 15/187; G10L 15/02; G10L 15/22; G10L 2015/025; G10L 2015/223

(57) ABSTRACT

Systems and methods are provided for recommending voice-based commands based on preferred speech characteristics. A voice-based interface receives a voice input including a first command. The voice-based interface determines, based on one or more user preferences, that the command does not fulfill preferred speech characteristics indicative of a speech efficiency and/or a speech naturalness. The voice-based interface identifies a second command that fulfills the preferred speech characteristics indicative of one or both of the speech efficiency and the speech naturalness. The voice-based interface generates for output a response including a recommendation of the second command.

### BACKGROUND

One or more embodiments discussed in the present disclosure relate to voice-based interface systems and associated methods. One or more of the systems and methods described herein provide for generating a recommendation indicative of a voice command based on one or more preferred speech characteristics.

### SUMMARY

Voice-inputted commands and associated natural language processing (NLP) have been developing to allow voice-based input using various levels of natural language, e.g., to execute device functions, perform searches, converse, or other actions. For example, potential commands for the same action may vary based on phrases, words, speech styles, tones, and/or other characteristics of the voice-based input. In some approaches, a voice-based interface system provides visual and/or audible responses to received commands but cannot determine whether a received command follows preferred speech characteristics, such as a preferred speech efficiency or a preferred natural speech style (e.g., similar to a conversation or other structure emulating a person speaking). Moreover, in such approaches, a voice-based interface system may not provide recommended commands that accurately reflect the preferred speech characteristics. For example, a device may receive a voice input including keywords having fewer syllables to reduce the amount of time for speaking the voice input, but a user's interaction history indicates a preference for a natural conversational style. The device may not provide an alternate command that would align with the preferred natural conversational style.

In one approach, user-defined custom commands or keywords may be stored in association with a device function as a voice-activated macro, but defining the custom commands may involve a complicated and/or time-consuming setup. In another approach, alternate commands may be discovered by manually inputting different versions of a command through an exhaustive systematic search, which consumes additional time and system resources (e.g., number of operations, processing time, power consumed, occupied storage space, etc.). In a third approach, a user interface (UI) may display text for a command and does not determine if using the shown command would be beneficial and/or include preferred speech characteristics.

Accordingly, there is a need for voice-based interface systems that recommend voice commands that more accurately align with user preferences including preferred speech characteristics.

To help address the above-discussed needs, systems and methods are described herein for providing voice command recommendations based on one or more preferred speech characteristics. In some beneficial aspects, a voice-based interface system implementing one or more processes described herein reduces the time and system resources consumed and increases accuracy when determining a preferred command as compared to other approaches, such as through user-defined macros or through manual discovery of alternate commands. That is, a voice-based interface on a device can identify an alternate command based on user information pertinent to a user profile and recommend the alternate command (e.g., indicated implicitly or explicitly in a notification), which avoids excessive manual input for entering a user-defined macro and avoids performing an exhaustive search. The voice-based interface system may determine an alternate command with a predicted usage benefit, such as by reducing the time to capture a spoken command, improving the speech flow of a command phrase, making a command sound more natural, improving the natural conversational style, etc.

In some embodiments, a voice-based interface receives a voice command. The voice-based interface may determine, based on one or more preferences, that the command does not fulfill the preferences (e.g., preferred speech characteristics such as a preferred speech efficiency and/or a preferred speech naturalness). Based at least in part on determining that the command does not fulfill the preferences, the voice-based interface identifies an alternate command that may better fulfill the preferences. In some embodiments, the voice-based interface determines, based at least in part on the user interaction history, that usage of the alternate command corresponds to a predicted benefit. For example, the user interaction history may show frequent usage of a command, and the voice-based interface may determine that the alternate command would be beneficial for frequent usage based on various characteristics including shorter expected speech duration, fewer keywords, fewer syllables, and/or lower pronunciation complexity. The voice-based interface generates for output a response including a recommendation of the alternate command. The voice-based interface may perform the voice command, such as by causing a device to execute an action corresponding to the voice command. The voice-based interface may be connected to one or more network-connected devices, such as in an Internet-of-Things environment, home automation network, etc.

In some embodiments, a voice input comprising a first command is received. One or more speech characteristics of the first command are computed. The one or more speech characteristics may indicate a speech efficiency and/or a speech naturalness of the first command. For example, a voice-based interface may compute, based at least in part on the voice input, the one or more speech characteristics using one or more language models. One or more user preferences are identified that indicate preferred speech characteristics. For example, the one or more user preferences may indicate a preferred speech efficiency and/or a preferred speech naturalness. The one or more speech characteristics of the first command and the one or more user preferences are compared. The one or more speech characteristics may not align with the one or more user preferences. Based at least in part on determining that the one or more speech characteristics do not align with the one or more user preferences, one or more candidate commands corresponding to the first command are retrieved. One or more speech characteristics of each candidate command are compared with the one or more user preferences. A second command of the one or more candidate commands is selected based on the comparison. That is, the one or more speech characteristics of the second command align with the one or more user preferences. For example, a speech naturalness of the second command may fulfill the preferred speech naturalness. A response corresponding to the voice input is generated for output. The response indicates the second command.

As an illustrative, non-limiting example, a media device (e.g., including a virtual assistant) may detect a user's voice input, such as by identifying a wake word or phrase. The voice input may be, “Hey assistant, could you please fast-forward to about 20 seconds later in the song?” Here, the wake phrase may be or include, “Hey assistant.” The media device parses the voice input and may identify words and/or phrases corresponding to a command for a target device to perform a device action (e.g., “you,” “fast-forward,” “20 seconds,” “later,” “in the song”). The device determines one or more speech characteristics, such as based on natural language understanding (NLU) analytics of the identified words and/or phrases. Here, the device may compute a speech naturalness score indicating how closely the voice input emulates human speech as part of the NLU analytics. The device compares the speech naturalness score to one or more stored user preferences including a preferred speech naturalness score. If the speech naturalness score is different than the preferred speech naturalness score, the device may access stored commands and identify an alternate command associated with a speech naturalness score that is closer to the preferred speech naturalness score. The device generates and/or outputs a response indicating the alternate command. Here, the device may generate a voice output, e.g., using speech synthesis to generate audio corresponding to the phrase, “Skipping 20.” In some embodiments, the device generates for display a visual component, such as a text notification, that states a command phrase, “Skipping 20.” The target device executes the device action by fast-forwarding 20 seconds in the currently playing song.

In some embodiments, a voice-based interface may determine a predicted benefit of usage for an alternate command. For example, a user interaction history may indicate that one or more commands were previously received for displaying event scores after a sporting event has ended. A voice-based interface may prevent recommendations of an alternate command if the history indicates a single instance or a few instances (e.g., infrequent usage and/or low predicted benefit). If a user interaction history indicates that the command to display event scores is received after every sporting event and/or after key highlights of the sporting events (e.g., frequent usage, high predicted benefit), the voice-based interface may provide a recommended alternate command that has a higher speech efficiency score than the originally received command.

In some embodiments, the voice-based interface may determine that a predicted benefit meets or exceeds a minimum improvement threshold for recommending an alternate voice-based command. For example, user preference data may indicate that a user profile has a high naturalness weight for speech naturalness. The user interaction history may indicate frequent usage of a command with high speech efficiency and a low speech naturalness (e.g., outside a naturalness threshold based on the naturalness weight). If the user preference data indicates a low efficiency weight for speech efficiency, the voice-based interface may recommend an alternate command that has a higher speech naturalness, such as an alternate command that increases a speech naturalness score by five and decreases a speech efficiency score by eight. In this example, the alternate command may have a weighted combined score based on summing the weighted speech characteristic scores (e.g., speech naturalness and speech efficiency). The voice-based interface may recommend the alternate command based at least in part on determining that the weighted combined score meets or exceeds the minimum improvement threshold.

In some embodiments, the voice-based interface may generate a recommendation indicating the command using a recommendation template for recommending an alternate command. The recommendation template may follow an implicit suggestion or an explicit statement. For example, the voice-based interface may indicate the recommended command implicitly by incorporating the command in a response to receiving a voice input, such as “Performing [COMMAND].” For example, the voice-based interface may indicate the recommended command using an explicit statement, such as “Did you know you can simply say [COMMAND]?” The voice-based interface may output the recommendation at a plurality of times and/or generate a second recommendation based on a different template for output at a plurality of other times to recommend the alternate command. The voice-based interface may determine whether a predicted benefit would improve command usage (e.g., by reducing time used for a frequently used command) and whether previously recommended commands were used. Based on these criteria or others, the voice-based interface may adjust the recommendation of the alternate command. As an illustrative example, a voice-based interface selects an alternate command. The interface generates a recommendation indicating the command implicitly by incorporating the command in a voice output, text notification, etc. The received voice input may include a received command such as “Make a phone call to Emily,” and the alternate command may be “Call [CONTACT]” which corresponds to a higher speech efficiency score than the received command. The interface may generate for output a voice response, such as “Call Emily,” to indicate a command phrase with higher speech efficiency.

In some embodiments, the voice-based interface may determine that a recommended command is not used after outputting the recommendation in an implicit format. The voice-based interface may stop suggesting the command using the implicit format. Additionally, or alternatively, the voice-based interface may determine a predicted usage benefit and, based at least in part on determining the predicted usage benefit, generate a second recommendation that suggests the recommended command using an explicit format. For example, the predicted usage benefit may meet or exceed a minimum improvement threshold, and the voice-based interface selects the explicit recommendation format to suggest the recommended command.

In some embodiments, a voice-based interface associates an alternate command with one or more user preferences (e.g., in a command list). For example, the voice-based interface may determine that the alternate command (e.g., “Skipping 20”), or variant thereof (e.g., “Skip 20”), is received after the recommendation of the alternate command was outputted. Based at least in part on the determination, the voice-based interface may store (e.g., in a user profile) the alternate command as a preferred command corresponding to the device action. The recommended command may be mapped to a corresponding device action. The recommended command may be associated with one or more speech characteristics, such as speech naturalness and/or speech efficiency. For example, the phrase “Skipping 20” may be stored in a command list that maps the phrase to the action of fast-forwarding 20 seconds in a song or other content currently playing at a target device. The phrase “Skipping 20” may be stored in the command list including a high speech efficiency score or another indicator for speech efficiency.

In some embodiments, a voice-based interface may generate a recommendation of a more distinguishable alternate command (e.g., including distinguishable phonemes) based on speech characteristics corresponding to a user profile and environmental factors. As described herein, the term “distinguishable command” refers to a command, a phrase, a word, and the like that, when spoken, is identifiable (e.g., more detectable) as compared to ambient audio or other noise that may be present at the time the command is spoken. Some example speech characteristics related to distinguishability may include speech volume, pronunciation (e.g., phones, phonemes), accent, and/or dialect. The voice-based interface may identify, from a command, one or more individual words, syllables, phrases, and/or other parts of the command, and determine distinguishability of the command based on the environmental factors. For example, a user profile may indicate a low average speech volume (e.g., a user talks quietly). The voice-based interface may detect a high level of background or ambient noise. The voice-based interface may identify two candidate commands with preferred speech characteristics, such as “Turn it down” and “More mellow.” In this example, the voice-based interface may identify more distinguishable phonemes in one of the candidate commands (e.g., a hard “t” sound) based on the high level of background noise and recommend “Turn it down.”

In some embodiments, the voice-based interface may modify words, phrases, etc., of an alternate command to adjust speech characteristics related to distinguishability of the command, such as by including distinguishable phonemes based on the level of background noise. For example, the voice-based interface may identify “buying song” as an alternate command but respond with a modified version of the identified command such as “purchasing track,” which includes phonemes that are distinguishable in a noisy environment (e.g., “p,” “tr,” etc.). The voice-based interface may track levels of background noise, noise trends, etc., and/or predict expected levels of background noise, e.g., via one or more sensors communicatively coupled to the voice-based interface. The voice-based interface may modify alternate commands to accommodate the observed and/or predicted environmental factors, such as the background noise. That is, the voice-based interface may identify keywords, or other parts, of a command and replace the identified keywords with word(s) having more distinguishable speech sounds based on the environmental factors. For example, a user history may include data indicating that a loud fan is on during a first time interval (e.g., during summer) and off during a second time interval (e.g., during winter). The voice-based interface may identify an alternate command, such as “Please fast-forward ahead twenty secs.” The voice interface, based at least in part on the expected noise level of the loud fan, may adjust the alternate command to include detectable speech sounds during the summer season, such as “Please skip ahead twenty seconds,” where the terms “fast-forward” and “secs” are respectively replaced with “skip” and “seconds.” The voice-based interface may recommend the adjusted command even if the fan is detected to be inactive during the summer season (e.g., the noise level is lower than expected). As another example, a user history may indicate that the background noise level has increased, such as if a user has moved near train tracks, causing higher background noise than the previous residence had without train tracks nearby. The voice-based interface may identify and/or adjust an alternate command having distinguishable phonemes based on the increased background noise level. Here, the alternate command may not meet some preferred speech characteristics (e.g., naturalness, efficiency) but may have increased distinguishability (e.g., be more easily detectable) over the increased background noise level.

As described herein, a voice-based interface system identifies and recommends an alternate command that more accurately follows user preferences including preferred speech characteristics and may determine a predicted benefit of the alternate command.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIGS. 1A-1B (collectively referred to herein as FIG. 1) depict some illustrative examples of a voice-based interface recommending a command based on preferred speech characteristics, in accordance with some embodiments of this disclosure;

FIG. 2 depicts an illustrative example of a voice-based interface generating a command recommendation based on preferred speech characteristics, in accordance with some embodiments of this disclosure;

FIG. 3 is an illustrative data flow diagram of generating a command recommendation based on preferred speech characteristics, in accordance with some embodiments of this disclosure;

FIG. 4 depicts an example process including comparing one or more commands and preferred speech characteristics, in accordance with some embodiments of this disclosure;

FIG. 5 depicts some illustrative examples of determining one or more speech characteristics of a command, in accordance with some embodiments of this disclosure;

FIG. 6 depicts illustrative user equipment, in accordance with some embodiments of this disclosure;

FIG. 7 depicts an example voice-based interface system including illustrative user equipment, in accordance with some embodiments of this disclosure;

FIG. 8 is a flowchart of an illustrative process for generating a command recommendation based on user preferences, in accordance with some embodiments of this disclosure;

FIG. 9 is a flowchart of an illustrative process including recommending a command that aligns with user preferences, in accordance with some embodiments of this disclosure; and

FIG. 10 is a flowchart of an illustrative process including determining a recommendation format for providing a command that aligns with user preferences, in accordance with some embodiments of this disclosure.

### DETAILED DESCRIPTION

The present disclosure describes, at least in part, systems and methods for recommending a voice-based command based on one or more preferred speech characteristics.

As referred to herein, the terms “voice-based interface,” “voice user interface,” and “voice interface” refer to a user interface enabling voice-based interactions (e.g., spoken commands, questions, conversations, etc.) with one or more computing devices, systems, etc. The term “voice-based interface system,” and variants thereof, refer to a computing system including a voice-based interface, such as at the operating system level. A voice-based interface may be implemented in any device capable of receiving a voice input including smart hub devices, home automation devices, smarthome assistants, automotive interfaces, gaming console systems, a voice remote control, a set-top box, streaming devices, extended reality devices, wearable devices, and more.

As referred to herein, the term “virtual assistant” refers to an autonomous electronic entity including artificial intelligence-based agents capable of performing one or more tasks, services, functions, etc., using one or more devices or systems based on various input types such as voice inputs including commands, questions, or other verbal inputs, and/or text, gestures, or other non-voice-based inputs. A virtual assistant may also be referred to as a voice assistant and/or a digital assistant. As referred to herein, the term “virtual assistant system” may refer to a system including a virtual assistant, an associated language model or other machine learning models, a virtual assistant platform, a virtual assistant service, one or more interconnected devices capable of implementing a virtual assistant, a user interface capable of voice-based interactions, and/or associated devices including microphones, voice remote controls, smart speaker systems, etc., that may be interconnected through a network.

As referred to herein, speech characteristics refer to one or more characteristics of language related to speech (e.g., human speech, emulated speech, etc.) including and not limited to: syntax (e.g., sentence structure), semantics (e.g., word meanings), morphology (e.g., structure of one or more words), pragmatics (e.g., how language is used to communicate and convey intentions including communication styles), phonology (e.g., phonetics, speech sounds), prosodic information, words, phonemes, syllables, and more. Speech characteristics may include speech naturalness (e.g., how closely synthesized speech or associated text emulates how a human being would speak) and/or speech efficiency (e.g., the number of words, a speech speed and/or rate, and pronunciation complexity of the words, how much time to speak a command phrase, etc.). As referred to herein, a phoneme refers to any set of speech sounds regarded as a phonetic unit or a base sound which helps distinguish one word from another within a language.

Natural language processing (NLP) tasks that may be associated with analyzing speech characteristics (e.g., based on vocal input, associated text, etc.) include and are not limited to: voice activity detection, speech recognition, segmentation (e.g., speech segmentation, tokenization such as word segmentation, sentence segmentation, morphological segmentation, topic segmentation, etc.), phoneme recognition, intent classification, similarity comparison (e.g., semantic, phonetic, structural, intent, and other natural language aspects), text-to-speech generation, lemmatization, part-of-speech classification, stemming, grammar induction, parsing, lexical semantics, entity recognition, distributional semantics, sentiment analysis, terminology extraction, word-sense disambiguation, contextual linking (e.g., entity linking), relational semantics, semantic labeling (e.g., role labeling), discourse analysis, topic recognition, summarization, logic translation, natural language understanding and/or generation, dialogue generation, and content generation (e.g., prompt to images, audio, video, combinations thereof, etc.).

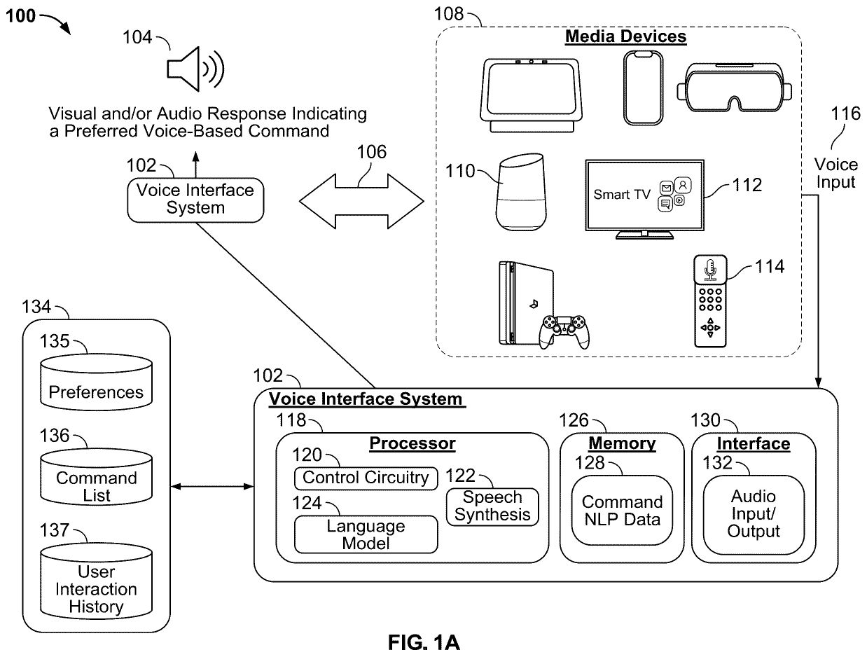

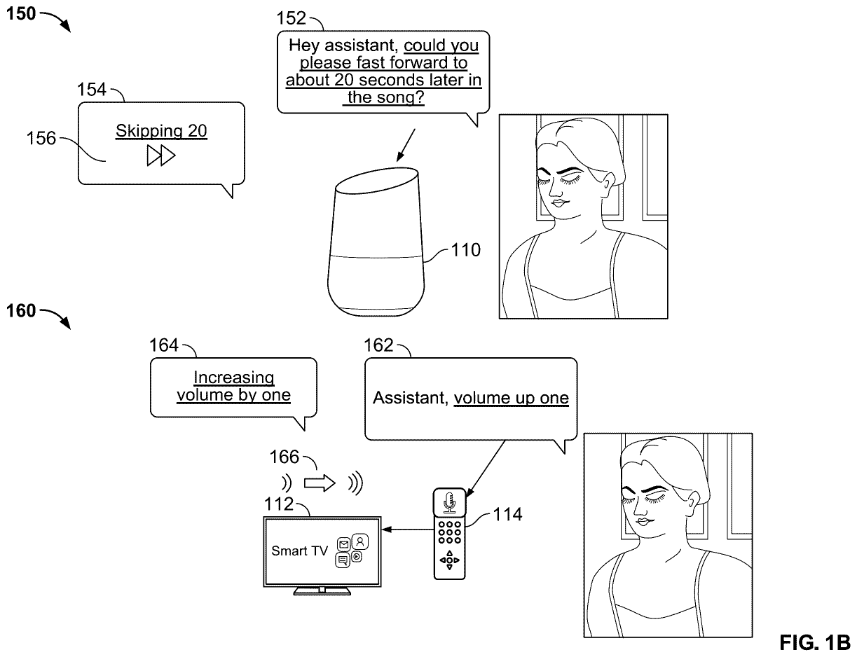

FIG. 1 depicts some illustrative examples of a voice-based interface recommending a command based on preferred speech characteristics, in accordance with some embodiments of this disclosure. FIG. 1A depicts an example system 100 including a voice interface system 102 connected to and/or integrated with one or more media devices 108 (e.g., a virtual assistant device 110, a smart display device 112, a voice-capable remote 114, etc.) or other user equipment. FIG. 1B depicts some example scenarios 150, 160 of the system 100 generating a command recommendation based on user preferences including one or more preferred speech characteristics.

Referring to FIG. 1A, the voice interface system 102 includes processor 118 and associated circuitry, memory 126, and interface 130. The processor 118 includes control circuitry 120, speech synthesis circuitry 122, and/or circuitry associated with a language model 124 (referred to as language model 124). The memory 126 may store natural language processing data 128 including data associated with a plurality of commands. The memory 126 may include other data associated with the voice interface system 102 and/or any of the devices 108 including device actions, device capabilities, identifiers, user information, etc. The interface 130 may include audio input/output (I/O) circuitry 132. The voice interface system 102 may include or be communicatively coupled to a user information database 134. The database 134 may be stored locally on the memory 126 and/or accessible through a network-connected environment (e.g., through cloud-based services). The voice-based interface may be connected to one or more network-connected devices, such as in an Internet-of-Things environment, home automation network, etc. The database 134 includes user preference data 135, command list 136, and a user interaction history 137. In some embodiments, the database 134 stores information for one or more user profiles associated with any of the media devices 108. For example, the user preference data 135, the command list 136, and the user interaction history 137 may include information specific to a profile related to the smart display device 112. The user preference data 135 may include one or more user characteristics (e.g., age, user history, writing style, vocal inputs, speech data, previous commands used, etc.). In some embodiments, the database 134 stores user information related to one or more media content sources (e.g., a streaming content provider, a social media platform, etc.) and may include demographic information or other aggregate user-based information for determining the user preferences.

Continuing with reference to FIG. 1A, the voice interface system 102 receives a voice input 116 (e.g., via the interface 130 and/or any of the devices 108 via a communication path 106). The voice interface system 102 processes the voice input 116 and identifies a first command. In some embodiments, processing the voice input 116 includes generating text corresponding to the voice input such as a speech-to-text transcription. Processing the voice input 116 may include digitizing the voice input, sampling audio of the voice input, analyzing the audio, identifying a user (e.g., using voice recognition), and/or determining contextual information from the voice input including the proximate environment, background noise, and/or other contextual features.

The voice interface system 102 determines speech characteristics of the first command. Here, the voice interface system 102 computes, using the language model 124, the speech characteristics indicative of a speech efficiency and/or a speech naturalness. For example, the voice interface system 102 may compute a value measuring the speech efficiency using NLP-based analysis, a speech speed or rate of the voice input, or other metrics. The voice interface system 102 accesses the user preference data 135 and/or other user information. Based at least in part on the user information, the voice interface system 102 identifies user preferences indicative of the preferred speech characteristics. The voice interface system 102 compares the speech characteristics of the first command and the user preferences. For example, the voice interface system 102 may identify a preferred speech efficiency from the user preferences and may compare the computed speech efficiency and the preferred speech efficiency, such as by comparing the respective values of the computed speech efficiency and the preferred speech efficiency.

In some embodiments, the voice interface system 102 may compare the user preferences and the first command using the language model 124. For example, the voice interface system 102 may identify a stored command from the user preferences (e.g., a frequently used command). The stored command may be associated with one or more preferred speech characteristics. In some embodiments, the stored command and the first command correspond to the same device action. In some other embodiments, the stored command and the first command correspond to different device actions. The voice interface system 102 inputs the first command and the identified stored command to the language model 124. The language model 124 may be used to compare one or more speech characteristics of the inputted commands. For example, the language model 124 may have been trained to determine how much a first sentence accurately emulates speech based on a second sentence. Here, the language model 124 may output a speech naturalness score to indicate how closely the speech naturalness of the first command meets the speech naturalness of the identified stored command. Some examples of comparable characteristics may include the sentence structure, keywords, number of words, number of syllables in the sentence, number of syllables per word, phrase length for an intent, and more. As an example, the speech naturalness score may indicate that the first command does not emulate the speech of the identified stored command (i.e., a low speech naturalness). Based on the low speech naturalness, the voice interface system 102 may determine that an alternate command should be identified that more accurately emulates the speech of the identified stored command as further described with reference to FIG. 1. As another example, the speech naturalness score may indicate that the first command accurately emulates the speech of the identified stored command (i.e., a high speech naturalness). Based on the high speech naturalness, the voice interface system 102 may determine that the first command meets the preferred speech naturalness as described in the following paragraph.

In some embodiments, the voice interface system 102 may determine that the speech characteristics of the first command align with the user preferences. For example, the language model 124 may output a speech naturalness score that indicates the speech naturalness of the first command meets, or is within a threshold range of, the speech naturalness of an identified stored command. To further elaborate this example without limiting, the threshold range may be about plus or minus 9%. The speech naturalness of the first command may be indicated by a value of about 0.42 on a scale from zero to one, and the speech naturalness of the identified stored command may be indicated by a value of about 0.43 on the same scale. The difference between the values is about 0.01, or about 2.3%, which is within the threshold range. Here, since the difference is within the threshold range, the voice interface system 102 determines that the speech naturalness of the first command aligns with the stored command based on the user preferences.

Continuing with reference to FIG. 1, the voice interface system 102 determines, based on comparing the first command and the user preferences, that the speech characteristics of the first command do not align with the user preferences. In some embodiments, the voice interface system 102 determines that the speech characteristics do not align with the one or more user preferences indicative of a preferred speech naturalness and/or a preferred speech efficiency. Based at least in part on the determination, the voice interface system 102 retrieves one or more candidate commands that correspond to the first command. Here, the voice interface system 102 accesses the command list 136. The command list 136 may include a mapping of a device action to one or more commands and/or other voice-based input. For example, the first command may correspond to a device action to increase a media volume by a specified amount, and some example commands in the command list 136 that correspond to the device action may include the phrases, “Increase volume by [AMOUNT],” “Volume plus [AMOUNT],” “The volume is too low,” and “The audio is too soft.” The voice interface system 102 may identify a subset of commands (e.g., of all the commands stored in the command list 136) that corresponds to the first command. The voice interface system 102 retrieves the phrases as candidate commands.

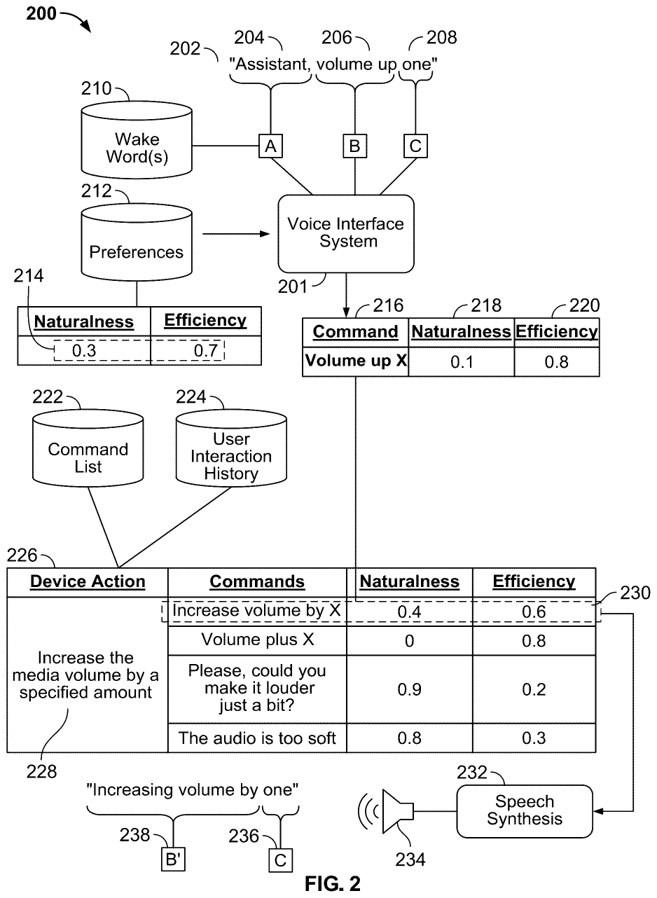

The command list 136 may include one or more device actions and associated command data, such as audio clips of voice inputs, text of the command(s), etc. The command list 136 may be stored as a data structure, such as table 226 described with reference to FIG. 2. In some embodiments, the command list 136 includes respective mappings between the one or more device actions and the associated commands. The voice interface system 102 may generate and/or update the command list 136 based on the user interaction history 137. As an illustrative example, the voice interface system 102 may identify, from previous voice inputs in the user interaction history 137, the spoken phrase “Increase volume by four.” That is, the user interaction history 137 may include speech audio data and/or a speech-to-text transcription of the phrase “Increase volume by four.” The voice interface system 102 determines (e.g., using the language model 124 based on the speech audio data and/or transcription) that the phrase includes a command (e.g., “Increase volume by [AMOUNT]”) and/or the device action associated with the command (e.g., increasing a media volume by a specified amount). The voice interface system 102 may determine which device action is associated with the command, e.g., by querying device actions related to one or more words in the command (e.g., “volume”). Here, the voice interface system 102 receives, based on the query, device actions related to volume, such as increasing volume of media, decreasing the volume of communications, muting the volume, etc. The voice interface system 102 may determine that the command is associated with increasing volume of media by an amount based on one or more keywords of the command (e.g., “increase,” “volume,” “four”). In some embodiments, the command list 136 includes pre-defined commands for one or more device actions. The voice interface system 102 may compare a command in a voice input and the pre-defined commands to determine the device action, such as by determining that the keywords, “Increase,” “volume,” etc., are included in a pre-defined command for increasing a media volume. The voice interface system 102 generates and/or stores a mapping between the command (e.g., “Increase volume by [AMOUNT]”) and the device action (e.g., increasing a media volume by a specified amount) in the command list 136. In an analogous manner, the voice interface system 102 may identify a plurality of commands (e.g., from the user interaction history 137) and store a mapping between the identified commands and a device action (e.g., as shown in table 226 described with reference to FIG. 2).

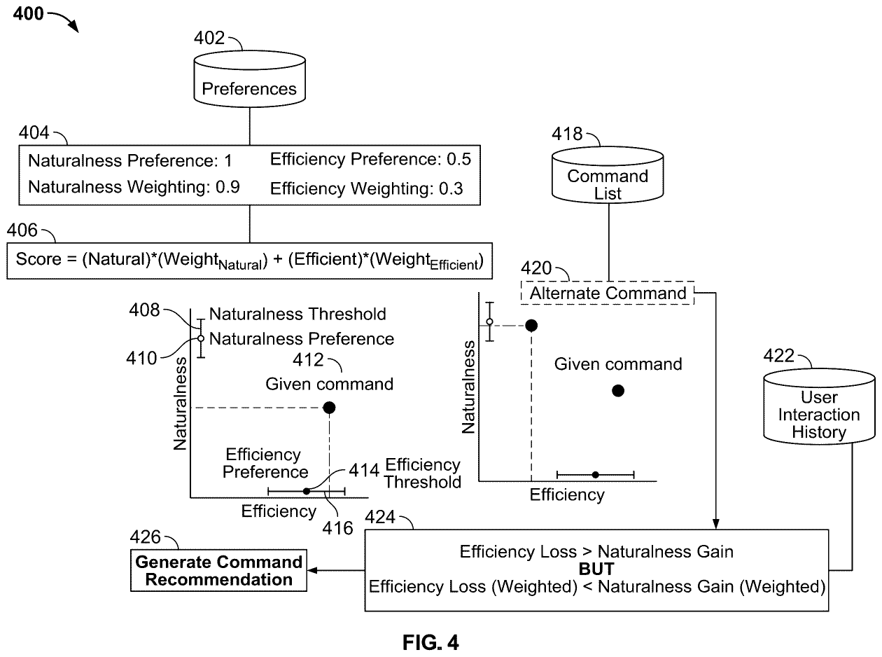

The voice interface system 102 compares the user preferences and one or more of the candidate commands. In some embodiments, the voice interface system 102 compares the user preferences and each candidate command using the language model 124. Based at least in part on comparing the candidate commands and the user preferences, the voice interface system 102 selects a second command of the candidate commands that aligns with the user preferences indicative of the preferred speech characteristics. For example, the voice interface system 102 may select an alternate command that meets the preferred speech naturalness and/or the preferred speech efficiency. The voice interface system 102 generates for output a response 104 corresponding to the voice input. In some embodiments, the voice interface system determines, based at least in part on the user interaction history 137, a predicted benefit for using the selected command as further described with reference to FIG. 4. The voice interface system 102 may cause any of the media devices 108 to output the response 104 (e.g., using the communication path 106).

The example scenario 150 at FIG. 1B depicts a voice interface system recommending a preferred command that would fulfill a preferred speech efficiency. At the scenario 150, a virtual assistant device 110 captures audio of a spoken phrase 152, e.g., through a microphone or other audio input component. Here, the phrase 152 includes a received command indicated as the underlined portion (e.g., “Could you please fast-forward to about 20 seconds later in the song?”). At the scenario 150, the voice interface system 102 generates and parses text of the first command. The voice interface system 102 may determine a user profile related to the phrase 152 by using voice recognition based on the audio of the phrase 152. In some embodiments, the voice interface system 102 may retrieve user preferences (e.g., the preference data 135 from the database 134) corresponding to the user profile. Additionally, or alternatively, the voice interface system 102 may access demographic information (e.g., from the database 134) to determine the preferences based on demographic data corresponding to the user profile including age, gender, marital status, location of residence, etc. The voice interface system 102 may identify the virtual assistant device 110 as a target device for performing or executing the command (e.g., based in part on the words “Could you” from the phrase 152). The target device for a command may be identified based on user input (e.g., audio) explicitly identifying a device (e.g., “perform this action on my iPhone,” “perform this action on Alexa,” etc.). In some instances, the voice interface system 102 (e.g., by itself or in coordination with one more or other systems or services) may disambiguate the user input or make one or more inferences to facilitate determining the target device (e.g., if the user has two phones that may be the target device, the system 102 may infer that the one nearest the user is the target device). In some instances, the system 102 may present follow-up questions (e.g., via audio or image/video) to request more specific information regarding the target device. For example, the system 102 may present the question, “Are you referring to your iPhone 13 or your iPhone 16”). In any event, the voice interface system 102 may determine that the received command is associated with fast-forwarding a currently playing song at the virtual assistant device 110. Here, the voice interface system 102 may determine that an efficient vocal command is preferred and that the received command is not vocally efficient and does not fulfill the preferred speech efficiency based on the user preferences. In response to determining that a more efficient vocal command is preferred, the voice interface system 102 identifies an alternate command that corresponds to the received command. That is, the voice interface system 102 may identify, from the command list 136, an alternate command associated with fast-forwarding in currently playing media content. The alternate command may include a phrase, “Skipping [AMOUNT],” where [AMOUNT] indicates how much time to fast-forward. Here, the voice interface system 102 synthesizes audio for a vocal response 154 stating, “Skipping 20,” indicating the alternate command that would fulfill the preferred speech efficiency. The voice interface system 102 may cause the target device (e.g., the virtual assistant device 110) to perform the device action 156, e.g., by fast-forwarding 20 seconds in a currently playing song.

The example scenario 160 at FIG. 1B depicts a voice interface system recommending an alternate command that fulfills a plurality of preferred speech characteristics. Here, the alternate command may meet a preferred speech efficiency and a preferred speech naturalness. A voice-capable remote 114 may be coupled to a smart display device 112 (e.g., through a direct wireless connection, using one or more communication paths through a local network, etc.). The remote 114 captures audio of a spoken phrase 162. The phrase 162 includes a received command (e.g., “Volume up one”). At the scenario 160, the voice interface system 102 processes the received command in an analogous manner to the example scenario 150. The voice interface system 102 may determine that a target device is the remote 114 and that the received command corresponds to increasing a media volume at a connected device, such as the smart display device 112 in this example. The voice interface system 102 determines that the user preferences indicate a plurality of preferred speech characteristics, and that the received command does not fulfill one or more of the preferred speech characteristics. Here, the preferred speech characteristics may include a preferred speech efficiency and a preferred speech naturalness. The phrase “volume up one” may be vocally efficient but does not emulate a natural speech style (e.g., based on a corresponding user profile). The voice interface system 102 identifies an alternate command (e.g., “Increase volume by [AMOUNT]”). The voice interface system 102 may generate a vocal response 164 (e.g., “Increasing volume by one”) and/or a visual response (e.g., displaying visual elements such as text stating, “Increasing volume by one,” an icon, animation, etc., associated with increasing a volume, and more). The voice interface system 102 may cause the remote 114 to perform a device action 166, such as increasing the volume of the smart display device 112.

In some embodiments, the response 104 may include visual and/or audio components. For example, the voice interface system 102 may generate for display a notification including notification text, e.g., as part of an output based at least in part on receiving a voice input. The voice interface system 102, or an associated display screen, displays the notification including words, phrases, etc., corresponding to the second command. In addition to the notification text, the response 104 may include other visual elements (e.g., icons, animations, other images, etc.). The response 104 indicates the second command as a recommended command. As a second non-limiting example, the response 104 may include speech audio stating the second command. That is, the voice interface system 102 may generate a text prompt including the second command and generate, using speech synthesis circuitry 122, the speech audio based at least in part on the text prompt. In some embodiments, the speech synthesis circuitry 122 is associated with a text-to-speech generative model, and generating the speech audio for the response 104 includes inputting the text prompt to the text-to-speech machine learning model.

In some embodiments, the voice interface system 102 may store the second command associated with the user preferences (e.g., such as in a user profile, the database 134, etc.). For example, the voice interface system 102 may retrieve or compute (e.g., using the language model 124) speech characteristic scores of the second command, such as an efficiency score corresponding to a speech efficiency of the second command and/or a naturalness score corresponding to a speech naturalness of the second command. The second command and the computed speech characteristic scores are stored in the preference data 135. In some embodiments, the second command may be stored as a reference command for comparing to speech characteristics of subsequently received voice inputs. For example, the stored command may be “Increasing volume by one,” and a later-received voice input may be “Change volume by plus one.” The voice interface system 102 may compare the stored command and the later-received voice input for determining that the speech characteristics of the later-received voice input align with the preferred speech characteristics.

In some embodiments, the command list 136 includes device actions and associated commands for various functions of the media devices 108. For example, the command list 136 may include commands for searching movies or other content (e.g., for voice-capable remote 114), changing channels (e.g., for smart display device 112), accessing music, activating a smart home function (e.g., for virtual assistant device 110), etc. Some example commands for searching action movies may include the phrases, “Look up some action movies,” “Find action shows,” and “Search action.” The command list 136 may include speech characteristics associated with each command, such as speech efficiency scores and/or speech naturalness scores as described with reference to FIG. 2. The command list 136 may be stored in a database including voice-enabled actions, alternate commands for each action, and scores, ratings, values or other quantities (“scores” henceforth) for speech characteristics of the commands. For example, a device action may be to capitalize selected text (e.g., last dictated text), and associated commands may include phrases such as “Capitalize that,” “Cap that,” “Uppercase that,” “All caps,” etc., with naturalness scores, efficiency scores, and/or other speech characteristic scores. The voice interface system 102 may identify from the database an alternate command for capitalizing the text and compare the respective scores.

The voice interface system 102 may compare the one or more user preferences and one or more speech characteristics of a candidate command by retrieving speech characteristic scores of the candidate command (e.g., from the command list 136) and comparing the retrieved scores and the user preferences. In some embodiments, comparing the one or more user preferences and one or more speech characteristics of a candidate command includes comparing audio and/or text corresponding to the candidate command. For example, speech audio data of the candidate command may be retrieved. The voice interface system 102 analyzes, using the language model 124, the speech audio data and/or a speech-to-text transcription. The voice interface system 102 computes the speech characteristic score(s) of the candidate command based on the analysis and compares the score(s) to preferred speech characteristic scores from the user preferences.

In some embodiments, the voice interface system 102 accesses the user interaction history 137 and retrieves previous interactions (e.g., voice-based commands) and associated speech characteristic scores. The voice interface system 102 may calculate average values of the associated scores. The average values may be weighted by frequency or recency of use for a command. The voice interface system 102 may determine other user speech characteristics based on the user interaction history 137. In an embodiment, the voice interface system 102 determines the speech efficiency score, e.g., by calculating (or accepting as input) a measure (e.g., average) of a user's speech speed (e.g., in words per minute or other analogous units) and dividing the number of words by that measure. In an embodiment, when determining speech efficiency, the voice interface system 102 may consider a combination of phonemes that constitute a spoken word as well as transitions between words. In an embodiment, the voice interface system 102 may consider individual differences based on a user command history. For example, the voice interface system 102 may identify, from the user interaction history 137, previous vocal inputs, the amount of time used to speak the previous vocal inputs, the number of words, phonemes, or other speech factors indicating duration of the vocal input, and more. The user interaction history 137 may correspond to an individual user's profile, and the voice interface system 102 determines the speech efficiency based on the vocal inputs of the individual profile. In some embodiments, the user interaction history 137 may include vocal inputs based on a plurality of user profiles, and the voice interface system 102 determines the speech efficiency based on the vocal inputs of the plurality of user profiles. The voice interface system 102 may compute an average speech pace by dividing the respective number of words in the vocal inputs (or other speech parts of the vocal inputs including number of phonemes, syllables, transitions, and/or a combination thereof) and the respective times for speaking the vocal inputs. The voice interface system 102 may predict an amount of time for speaking a command, e.g., by dividing the number of words in the command and the average speech pace.

In some embodiments, the user preference data 135 may include explicitly inputted preferred speech characteristics. For example, the voice interface system 102 or another device may have generated a prompt for manually selecting preferred sentences, adjusting a slider or other interface element, selecting options indicating preferred speech patterns, styles, etc. The selections and other interactions are stored in the user preference data 135 for later access by the voice interface system 102.

In some embodiments, the voice interface system 102 may access demographic information to identify user preferences for speech characteristics. Demographic information may indicate a probability of one or more preferred speech characteristics. For example, a user profile may indicate the user's age may be in an older age demographic. Some preferred speech characteristics may be associated with the older age demographic (e.g., in a look-up table, a database, etc.), such as high natural language, a conversational speech flow, and/or a conversational sentence structure. Here, the voice interface system 102 may retrieve, from a database, the speech characteristics associated with the older age demographic.

In some embodiments, the voice interface system 102 may determine preferred speech characteristics based on the user preference data 135 and/or other user information. For example, the voice interface system 102 may access historical user data (e.g., the user interaction history 137) for a user profile and/or retrieve communication data. The voice interface system 102 may retrieve sent emails, text messages, social media, etc., from the user profile and analyze them (e.g., using NLU-based analytics, a language evaluation model, etc.) for preferred naturalness, efficiency, and/or other preferred speech characteristics.

In some embodiments, the voice interface system 102 determines a speech naturalness score based on comparing a command and a natural language structure. For example, the voice interface system 102 may identify one or more conversations (e.g., texts, voice messages, etc.) in the user interaction history 137. The voice interface system 102 may determine, using the language model 124, a conversational structure including syntax, grammar, parts of speech, and other aspects related to NLU-based analytics. For example, the conversational structure may be, “[SUBJECT], please do [ACTION] to [ACTION CRITERIA] in this [OBJECT].” The voice interface system 102 compares the command and the conversational structure, e.g., by performing a similarity comparison on the identified parts of speech. If the command includes all the parts of speech in the conversational structure, has similar syntax and grammar, follows a similar pattern, and more, the voice interface system 102 may compute a high speech naturalness score. For example, there may be four parts of speech in the conversational structure, and the voice interface system 102 identifies two of the four parts of speech in the command. The voice interface system 102 may compute a speech naturalness score of about 0.5. It is contemplated that any number of structural markers, and combinations thereof, may be included when computing a speech naturalness score based on a natural language structure.

In some embodiments, the voice interface system 102 determines that the preferred speech characteristics are different than what the historical user behavior indicates, such as based on the user interaction history 137 (e.g., emails, messages, etc.). For example, the voice interface system 102 may determine that previously sent short-form audio (e.g., one or more voice messages through a social media platform), emails, and/or other content indicate a speech pattern with high speech efficiency, such as by the user speaking in a concise manner in the voice messages. The voice interface system 102 determines that voice input 116 indicates a communication style with high speech naturalness, such as using a conversational tone and structure when speaking to the virtual assistant device 110. The voice interface system 102 determines that the communication style differs from the speech pattern in the user interaction history 137. That is, NLU-based analytics of the communications including user speech, fragments, sentences, etc., may indicate the preferred naturalness and other preferred speech characteristics have changed. The voice interface system 102 may update the stored preference data based on the determination that the preferred speech characteristics have changed.

In some embodiments, the voice interface system 102 may determine that a command has low speech efficiency (e.g., inefficient) and that the user interaction history 137 indicates a high usage frequency of the command. The voice interface system 102 may generate a highly efficient command (e.g., a shortcut) that may have low speech naturalness. For example, the user interaction history 137 may indicate a daily used command to check the weather of a location. The voice input may be “Tell me what the weather is today in Santa Fe, New Mexico.” The voice interface system 102 may determine that an alternate command with high speech efficiency is not stored in the command list 136. The voice interface system 102 may generate a recommendation indicating a shortcut command, such as an explicit recommendation stating “In the future, you can simply say W or weather to find out today's weather in Santa Fe, New Mexico.” Here, the voice interface system 102 may associate the recommended command (e.g., “W” or “weather”) to the same device action corresponding to the daily used command. In some embodiments, the voice interface system 102 may generate a notification including a selectable option to confirm acceptance of the suggested shortcut command.

In some embodiments, the voice interface system 102 may recommend an alternate command with increased speech naturalness that incorporates explicit and/or inferred elements of the voice input 116. For example, the voice interface system 102 may identify one or more keywords and/or associations from an originally received command, such as “Tell me what the weather is today in Santa Fe, New Mexico.” Here, the voice interface system 102 may identify the queried location (e.g., Santa Fe, New Mexico) and determine that the location is related to contact information for a user's contact (e.g., the residence of the user's daughter). The voice interface system 102 may retrieve the contact's name or another identifier (e.g., “Amy”) and generate for output a recommendation indicating a shortcut command, such as an implicit recommendation stating “Amy weather.”

It is appreciated that the example system 100 is intended to be illustrative and non-limiting, and a voice-based interface in the present disclosure may include, add, remove, substitute, and/or modify any circuitry or other component as described herein including those depicted in FIG. 1. It is noted that the circuitries and components are depicted separately for illustration. Any of the circuitries and components described herein may be implemented as part of a single device or circuitry, such as in the control circuitry 120, that is configured to execute the various functions and associated tasks. For example, the voice interface system 102 may be part of any of the devices 108, have components distributed among the devices 108, or be part of a separate device linked to any of the devices 108.

FIG. 2 depicts an illustrative example 200 of a voice interface system 201 generating a command recommendation 234 based on preferred speech characteristics 214, in accordance with some embodiments of this disclosure. One or more components depicted in the example 200 may correspond to one or more components of the system 100. Here, example 200 may depict the example scenario 160 for illustrative purposes. A voice input 202 is received by the system 201. The system 201 may determine that the voice input 202 includes parts 204, 206, and 208 (respectively labeled A, B, and C). The system 201 may identify part 204 as an activation phrase or wake word (e.g., from a database 210 including wake words associated with one or more devices). The system may determine that the part 206 corresponds to a device command (e.g., increasing a volume such as device action 228) and the part 208 as an action criterion (e.g., one unit).

The system 201 accesses preference data 212 including user information about the preferred speech characteristics 214. For example, a preferred speech characteristic may be represented as a single score (e.g., from zero to one) indicating a preference for a first characteristic or a second characteristic, such as between speech naturalness and speech efficiency. For example, preferences for a plurality of speech characteristics may be represented by an independent score for each speech characteristic. In the preference data 212, a preferred speech naturalness may be indicated by a speech naturalness score of 0.3, and a preferred speech efficiency may be indicated by a speech efficiency score of 0.7. The system 201 determines speech characteristics of the voice input 202. For example, the system 201 determines a command 216 and/or computes a speech naturalness 218 (e.g., a speech naturalness score of 0.1) and a speech efficiency 220 (e.g., a speech efficiency score of 0.8). The system 201 determines that the speech characteristics of the voice input 202 are different from one or more of the preferred speech characteristics 214. Here, the system 201 determines, based on comparing the respective scores, that the speech naturalness and the speech efficiency do not align with the preferred speech characteristics 214. The system 201 accesses a command list 222 and/or a user interaction history 224. The system 201 may identify a plurality of commands, arranged as table 226.

Here, table 226 depicts an example data structure for identifying an alternate command. The system 201 may determine, based at least in part on the identified device action 228, a plurality of commands as shown in the table 226. The command list 222 may include speech characteristic scores associated with each command in the table 226. In some embodiments, the system 201 may compute the speech characteristic scores for each command, such as by using one or more language models.

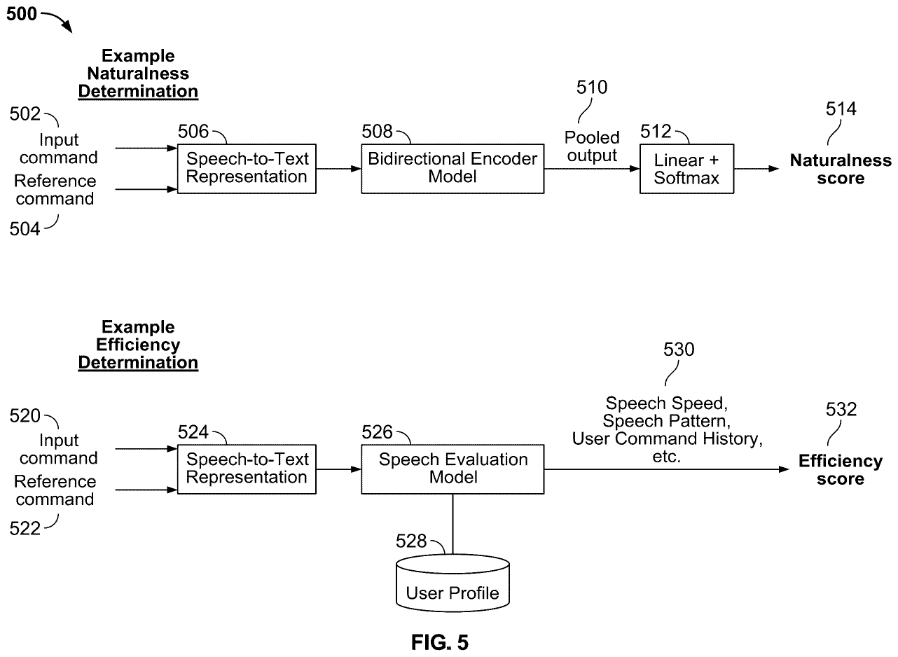

The voice interface system 201 may determine a speech naturalness score using one or more language models. In some embodiments, the voice interface system 201 may compute a speech naturalness score using a bidirectional encoder model, such as based on a bidirectional encoder representations from transformer (BERT) language model. The bidirectional encoder model may have been trained to predict if a sentence emulates natural speech and compute a naturalness score. For example, the voice interface system 201 may input a speech-to-text transcription of the voice input 202 and/or a reference sentence (e.g., a previous vocal command from the user interaction history 224) to calculate a speech naturalness score. An example of determining a speech naturalness score is described with reference to FIG. 5.

The voice interface system 201 may determine a speech efficiency score based on a voice input or other data related to vocal inputs. In some embodiments, the voice interface system 201 may compute a speech speed for determining the speech efficiency score. For example, the voice interface system 201 may compute the speech speed based on the voice input 202, previous vocal commands, and other interactions related to vocal inputs from the user interaction history 224. The voice interface system 201 may compute the speech speed by dividing the number of words in a voice input and the time to speak the voice input. Additionally, or alternatively, the voice interface system 201 may determine the speech speed based on the phonemes of one or more words of a voice input and transitions between the words. The voice interface system 201 determines the speech efficiency score based on the speech speed, such as by dividing the speech speed of the voice input 202 by the average speech speed (e.g., based on previous voice inputs from the user interaction history 224, from a user profile, or other user information). For example, the voice interface system 201 may predict an amount of time for speaking a command by computing an average speech pace based on previous voice inputs from the user interaction history 224 and determining the predicted amount of time based on the average speech pace and the number of words, syllables, transitions, etc., of a candidate command. In some embodiments, the voice interface system 201 may determine the speech efficiency score using a language model. An example of determining a speech efficiency score using a language model is described with reference to FIG. 5.

The preferences may include a weight for each speech characteristic. The weighting may represent an importance of the speech characteristic. The weights may be used to determine a preference threshold for a speech characteristic as described with reference to FIG. 4. The weights may be user-defined. For example, the system 201 may generate for display a prompt, or other interface element(s) including sliders, buttons, etc., indicating one or more options for defining the weights. For example, the system 201 may provide a calibration process to indicate the preference weights for speech characteristics. The system 201 may present example sentences, commands, prompts, etc., with pre-defined speech characteristics and associated scores. The system 201 receives one or more selections to indicate preferred versions (e.g., using sliders or other interface elements). Based on the selection(s), the system 201 may determine and/or store the preference scores and preference weights for the speech characteristics (e.g., in the preference data 212).

Based on the speech characteristics, the system 201 identifies a preferred command 230. The preferred command 230 includes speech characteristics that meet or are close to the preferred speech characteristics 214. For example, the preferred command 230 may have a speech naturalness score of 0.4 and a speech efficiency score of 0.6 as compared to the respective preferred scores of 0.3 and 0.7. The system 201 generates for output a response including the preferred command 230. Here, the system 201 generates text for synthesizing a voice response as the command recommendation 234 using speech synthesis circuitry 232. For example, the system 201 may generate text with parts 236 and 238 (respectively labeled C and B′). The system 201 may modify the preferred command 230 when generating the part 238. In some embodiments, the system 201 inputs the generated text to a text-to-speech model associated with the speech synthesis circuitry 232 and outputs the synthesized speech.

In some embodiments, the system 201 may receive a voice-based command. The system 201 may determine that the command has not been previously received, for example, if the command does not exist in the user interaction history 224. The system 201 may determine speech characteristic scores for the command. The system 201 may search the command list 222 for an alternate command. If the system identifies a plurality of potential candidate commands, the system 201 may select the alternate command with the closest speech characteristic score(s). The score(s) may be weighted by the user preferences. The system 201 may compare tradeoffs between speech characteristic scores to identify an alternate command having a combination of speech characteristics that correspond to the user preferences as described with reference to FIG. 4.

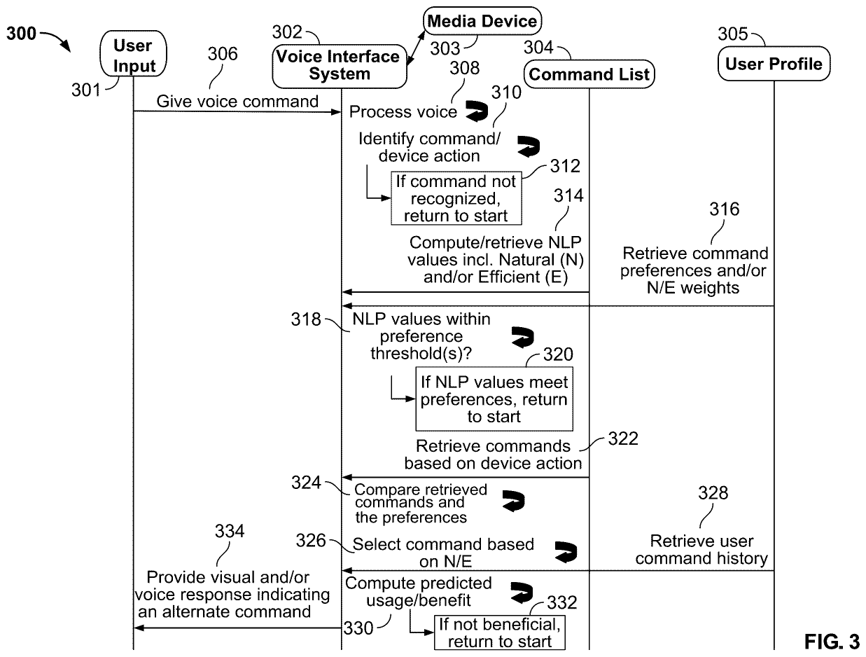

FIG. 3 is an illustrative data flow diagram 300 of generating a command recommendation based on preferred speech characteristics, in accordance with some embodiments of this disclosure. The data flow diagram 300 depicts interactions between user input 301, a voice interface system 302 (e.g., coupled to a media device 303), a command database 304 including a command list, and a user database 305 including a user profile or other user data. At interaction 306, the user input 301 provides a voice command to the system 302. For example, the media device 303 or another device may capture data associated with the user input 301 and provide the data to the system 302. At interaction 308, the system 302 processes the voice command. For example, the system 302 may generate a speech-to-text transcription of the voice command. Based at least in part on processing the voice command, the system 302 identifies a command and/or a corresponding device action. For example, the command may indicate that the media device 303 is a target device for the device action, and the system 302 may instruct the media device 303 to perform the device action at any time after processing the voice command. In some embodiments, the system 302 determines that the voice command is not recognized. For example, at interaction 312, the system 302 may determine that the identified command does not have a corresponding device action and stops processing the voice command from interaction 306.

Continuing with FIG. 3, at interaction 314, the system 302 determines the speech characteristic scores for the identified command. The system 302 may compute the speech characteristic scores and/or access a database for the speech characteristic scores. Here, the system 302 retrieves, from the command database 304, speech naturalness scores and/or speech efficiency scores that were computed (e.g., using natural language processing). At interaction 316, the system 302 accesses the user database 305. The system 302 may retrieve, from the user profile, voice-based command preferences, such as preferred scores, and/or associated weights corresponding to preferred speech characteristics (e.g., of voice-based commands). The command preferences may define preference criteria related to speech characteristics of voice-based commands. At interaction 318, the system 302 determines that the speech characteristic scores align or do not align with the command preferences. In some embodiments, the system 302 may determine whether a speech characteristic score of the identified command meets a preferred score or whether the speech characteristic score is within a range from the preferred score for the speech characteristic. For example, the system 302 may determine, based on a naturalness weight from the user database 305, a minimum and maximum speech naturalness score (e.g., 0.25 and 0.44 respectively) and determine that the speech naturalness score (e.g., 0.4) of the identified command does not equal the preferred score (e.g., 0.3) and is within a range defined by the minimum score and the maximum score (e.g., greater than 0.25 and less than 0.44). If the speech characteristic scores align with the command preferences at interaction 320 (e.g., the scores meet their respective preference criteria), the system 302 determines that an alternate command would not be suggested and continues with executing the command.

Here, the system 302 determines that the speech characteristic scores do not align with the command preferences. At interaction 322, the system 302 identifies and retrieves, from the command database 304, a candidate command(s) based on the device action. The system 302 may retrieve speech characteristic scores associated with the candidate command(s). At interaction 324, the system 302 compares the retrieved commands (e.g., their speech characteristic scores, text of each command, speech audio of each command, etc.) and the command preferences. At interaction 326, the system 302 selects an alternate command that aligns with the command preferences (e.g., based on the speech naturalness score and/or speech efficiency score meeting the command preference criteria).

At interaction 328, the system 302 retrieves historical user data, such as a user command history including previous voice-based commands. At interaction 330, the system 302 may compute a predicted benefit based on the user command history. If the predicted benefit does not meet a benefit threshold (e.g., a minimum improvement threshold), at interaction 332, the system 302 may determine that the alternate command should not be suggested and continues to execute the command. If the predicted benefit meets or exceeds a benefit threshold, the system 302 may generate a recommendation indicating the alternate command. At interaction 334, the system 302 provides a response to the user input 301. Here, the system 302 may generate for output a response including a visual-based and/or voice-based recommendation that indicates the alternate command.

It is contemplated that one or more processes related to the diagram 300 may be implemented, in whole or in part, on any voice-capable device (e.g., media devices 108, user equipment devices 600-601, user equipment 720, etc.) and/or any component thereof. One or more actions discussed in the diagram 300 may be incorporated into or combined with one or more actions of any other process(es) or embodiment(s) described herein.

FIG. 4 depicts an example process 400 for comparing one or more commands and preferred speech characteristics, in accordance with some embodiments of this disclosure. Here, the process 400 includes comparing a received command 412 and an alternate command 420 (e.g., from a command list 418) to preferences 402 including preferred speech characteristics 404. Here, a preferred speech naturalness score 410 is labeled Natural, a preferred speech efficiency score 414 is labeled Efficient, and respective weights are labeled Weight_{Natural} and Weight_{Efficient}. In some embodiments, the preference thresholds 408, 416 are determined based at least in part on the preference weights and the preferred scores. For example, the preference thresholds 408, 416 may be computed as a weighted sum of the aforementioned scores and preference weights or based on the lower score of the aforementioned scores. As another non-limiting example, the preference thresholds 408, 416 may have been user-defined (e.g., determined through a calibration process). The preference thresholds 408, 416 may define a minimum preferred score and a maximum preferred score for a respective speech characteristic (e.g., a threshold range around the preferred speech characteristic score). A combined score 406 may be computed based on a weighted sum of the preferred speech characteristics 404. Here, each speech characteristic may be independently weighted in the combined score 406.

Continuing with the example process 400, the preferred speech characteristics 404 may include a preferred speech naturalness of 1.0 with a naturalness weight of 0.9 and a preferred speech efficiency 0.5 with an efficiency weight of 0.3. The weights may be normalized for computing the combined score 406 such that the sum of the weights is one. Here, the normalized naturalness weight (i.e., Weight_{Natural}) would be 0.75 and the normalized efficiency weight (i.e., Weight_{Efficient}) would be 0.25. The combined score 406 may be computed as (combined score)=(naturalness score)*(normalized naturalness weight)+(efficiency score)*(normalized efficiency weight). Alternatively, the combined score 406 may be normalized, e.g., by dividing the combined score 406 by the sum of the unnormalized weights. That is, the combined score 406 may be computed as (combined score)=((naturalness score)*(naturalness weight)+(efficiency score)*(efficiency weight))/(sum of unnormalized weights). In this example, the received command 412 has a speech efficiency score that does not meet a preferred efficiency score 414. Here, the speech efficiency score falls within the preferred efficiency threshold 416. The received command 412 has a speech naturalness score that does not meet the preferred naturalness score 410 and that is outside the preferred naturalness threshold 408. In this example, the received command 412 does not align with the preferred speech characteristics 404.

The process 400 includes identifying and suggesting an alternate command 420 from the command list 418. In this example, the alternate command 420 may have a speech naturalness score that is close to the preferred naturalness score 410 and that falls within the preferred naturalness threshold 408. Here, the alternate command 420 has a speech efficiency score that is outside the preferred efficiency threshold 416. The alternate command 420 may be selected based on a tradeoff criterion 424 (e.g., comparing the high naturalness weight of 0.9 and the low efficiency weight of 0.3). The criterion 424 may be determined based on a user interaction history 422 and the preference weights. Here, the criterion 424 may be satisfied by comparing the weighted loss in the efficiency score and the weighted gain in the naturalness score. If the criterion 424 is satisfied, the alternate command may be determined to have a sufficient predicted benefit (e.g., meets a minimum improvement threshold) even if the alternate command has a speech efficiency score that is further from the preferred speech efficiency score 414 and/or falls outside the preferred efficiency threshold 416. In some embodiments, the combined score of the alternate command 420 may be greater than the combined score of the received command 412, which satisfies a tradeoff criterion. The system may identify a command that has the highest combined score of naturalness and efficiency. Here, based at least in part on determining that the criterion 424 is satisfied, the process 400 includes generating a command recommendation 426 for the alternate command 420.

In some embodiments, an alternate command having a combined score that satisfies one or more preference criteria (e.g., tradeoff criterion 424) is selected. For example, a preference criterion may refer to the greatest combined score. In embodiments where the speech characteristics 404 are weighted based on a single preference factor, the weights may be normalized such that the weights add up to one. A preferred speech characteristic score may be within a range from zero (e.g., inefficient) to one (e.g., efficient), and a preference weight (e.g., for speech efficiency) may be indicated using the same range. A preference factor may be 0.6. In this example, the preferred naturalness weight may be equal to the preference factor (e.g., 0.6), and the preferred efficiency weight may be computed as one minus the preference factor (e.g., 0.4). As another example, a received command for capitalizing selected text may be received. A preference factor may be 0.4, and a preference criterion may indicate that a preferred speech characteristic is leaning towards efficient vocal commands. The weighted combined score (e.g., analogous to the computation of combined score 406) may be computed as 0.6 for a received command. A plurality of alternate commands (e.g., “Capitalize that,” “Uppercase that,” “Cap that,” etc.) are identified from the command list 418. The alternate commands may have respective combined scores of 0.52, 0.7, 0.42 after weighting. Based on the preference factor, the alternate command with the lowest combined score may be selected (e.g., the alternate command having a combined score of 0.42). In an analogous manner, a preference criterion may indicate that the user preferences lean towards natural vocal commands, and the alternate command with the greatest combined score is selected (e.g., the alternate command having a combined score of 0.7). In some embodiments, if some alternate commands have the same combined scores after weighting, then an alternate command with the greatest combined score without weighting may be selected.

FIG. 5 depicts some illustrative examples of a system 500 determining one or more speech characteristics of a command, in accordance with some embodiments of this disclosure. Here, a first example of determining a speech naturalness score 514 is described, and a second example of determining a speech efficiency score 532 is described. The naturalness score 514 and the efficiency score 532 may be normalized, e.g., to be indicated by values on a scale from zero to one, or another scale.

Referring to the example naturalness determination, the system 500 receives an input command 502. The input command 502 may be a command from a received voice input or a candidate command. The system 500 identifies a reference command 504 (e.g., a sentence, previous vocal input, user-generated communications) based on the input command 502. In some embodiments, the system 500 generates respective text based on speech audio of the input command 502 and/or the reference command 504. The system 500 may retrieve text for the reference command 504. The system 500 determines a combined speech-to-text representation 506 for the command 502 and the reference command 504. For example, the system 500 may input speech audio of the commands 502, 504 to a speech-to-text model, generate respective sentences, and combine the sentences as the speech-to-text representation 506. The speech-to-text representation 506 is analyzed using a bidirectional encoder model 508 (e.g., BERT or another language model). The model 508 generates a pooled output 510 based on the speech-to-text representation 506. A linear model layer with softmax activation 512 is used to determine a probability of a naturalness label based on the pooled output 510. The probability is represented as the naturalness score 514.

The model 508 may include encoder (and/or decoder) architecture of a transformer model including an attention mechanism. In some embodiments, the model 508 is an encoder-only transformer model. The model 508 may include modules for tokenizing, token embedding, and/or token encoding. Tokens for particular NLP functions may be added in the speech-to-text representation 506 (e.g., [CLS] for classify, [SEP] for sentence separation, [MASK] for masking tokens). That is, the system 500 may modify the speech-to-text representation 506 by adding the tokens related to a next sentence prediction task. As an example, the speech-to-text representation 506 may be adjusted to have the structure, “[CLS](input command 502) [SEP](reference command 504) [SEP].” The model 508 may have been trained to predict whether a command emulates natural speech for computing a naturalness score based on a reference text. In some embodiments, the model 508 is pre-trained for determining one or more correlated characteristics related to a speech naturalness. Some example correlated characteristics may include informativeness, coherence, sentence quality, and more.

Referring to the example efficiency determination, the system 500 receives an input command 520. The input command 520 may be a command from a received voice input or a candidate command. The system 500 identifies a reference command 522 based on the input command 520. The system 500 may generate text based on speech audio of the input command 520 and/or reference command 522. Here, the system 500 may generate respective speech-to-text representations 524. The system 500 accesses a speech evaluation model 526. The model 526 may be a language model trained to evaluate user characteristics 530 including speech speed, speech pattern, user command history, pronunciation complexity, etc., based on a user profile 528 and/or other user information (not shown). Here, the system 500 may determine a speech efficiency score 532 based on the speech evaluation model 526 and/or the user characteristics 530. As an example, a user speech speed may be determined using the model 526, and the system 500 computes the efficiency score 532 by dividing a number of words in the input command 520 by the user speech speed. In some embodiments, the model 526 may be trained to determine one or more of the user characteristics 530 based on phonemes of previous vocal inputs from the user profile 528 and/or transitions between words of the vocal inputs.

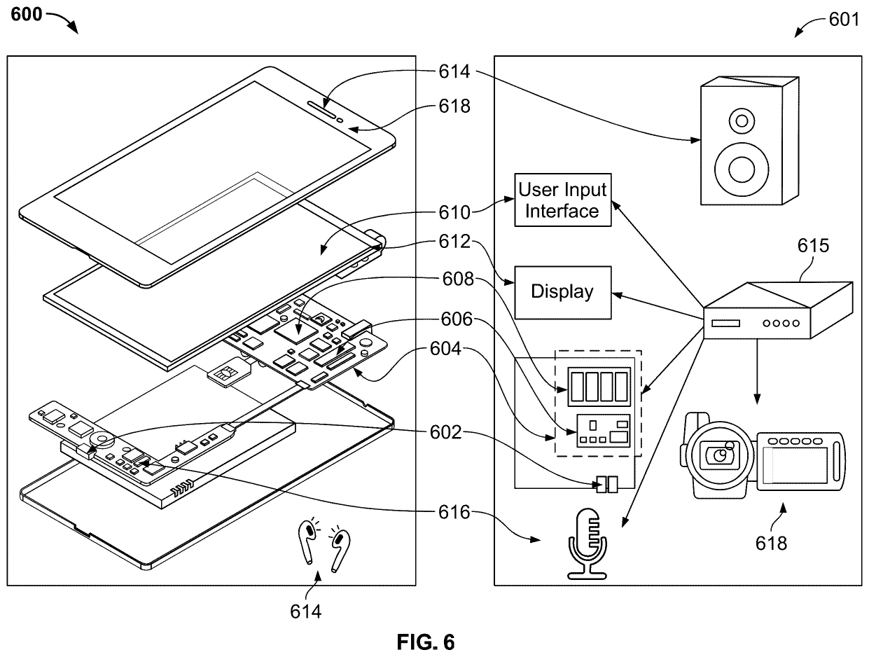

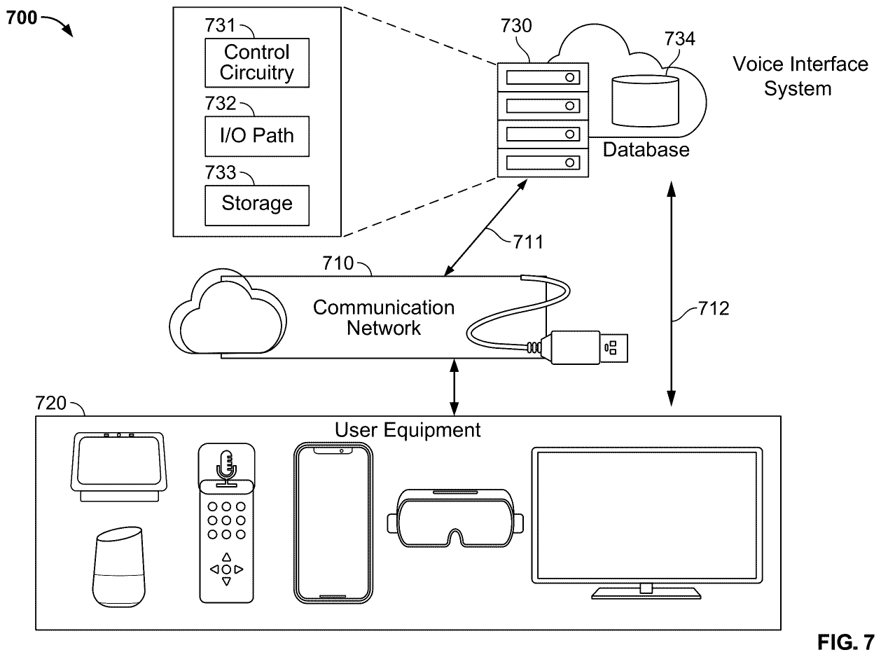

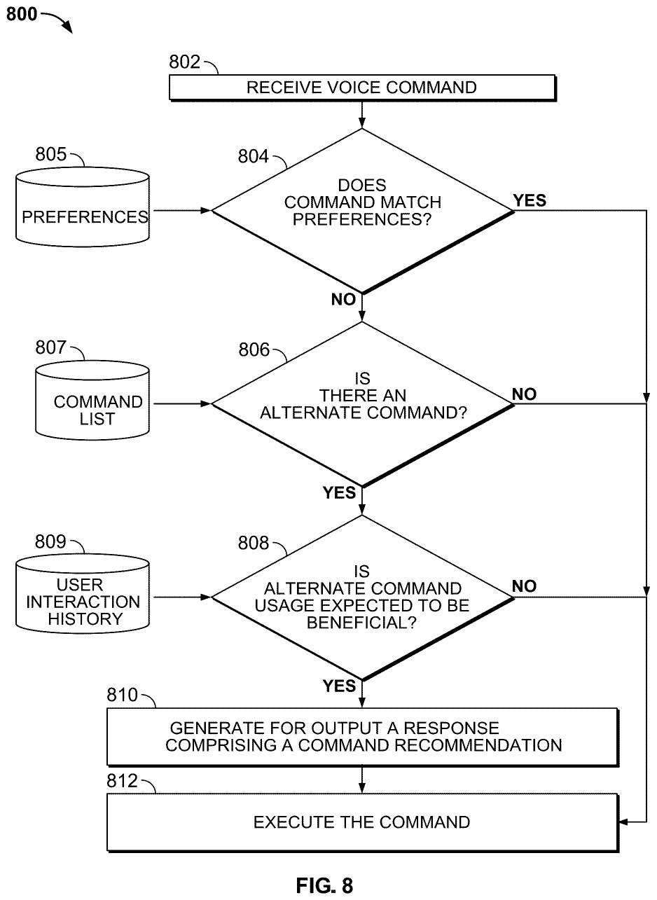

FIGS. 6-7 depict illustrative devices, systems, servers, and related hardware including a voice-based interface. FIG. 6 shows generalized embodiments of illustrative user equipment devices 600 and 601, in accordance with some embodiments of this disclosure. For example, user equipment device 600 may be a smartphone device, a tablet, a virtual reality or augmented reality device, or any other suitable device capable of receiving voice-based input and/or processing voice-based input. In another example, user equipment device 601 may be a user media equipment system, a controller system, a home automation hub, a control center, an infotainment system, etc. In this example, user equipment device 601 may include a coordinator device 615 (e.g., smart hub device). The coordinator device 615 may be communicatively connected to other devices including the user equipment device 600, microphone 616, audio output equipment 614 (e.g., speakers, headphones, etc.), and display 612. In some embodiments, display 612 may be a television display or a computer display. In some embodiments, the coordinator device 615 may be communicatively connected to user input interface 610. In some embodiments, user input interface 610 may be a remote-control device. The coordinator device 615 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. In some embodiments, the user equipment devices 600 and 601 and their components are integrated in a single personal device.

Each one of user equipment device 600 and user equipment device 601 may receive content and data via input/output (I/O) path (e.g., I/O circuitry) 602. I/O path 602 may provide content (e.g., broadcast programming, on-demand programming, Internet content, content available over a local area network (LAN) or wide area network (WAN), and/or other content) and data to control circuitry 604, which may comprise processing circuitry 606 and storage 608. Control circuitry 604 may be used to send and receive instructions, commands, requests, and other suitable data using I/O path 602, which may comprise I/O circuitry. I/O path 602 may connect control circuitry 604 (and/or processing circuitry 606) to one or more communications paths (described below). I/O functions may be provided by one or more of these communications paths but are shown as a single path in FIG. 6 to avoid overcomplicating the drawing. While the coordinator device 615 is shown in FIG. 6 for illustration, any suitable computing device having processing circuitry, control circuitry, and storage may be used in accordance with the present disclosure. For example, the coordinator device 615 may be replaced by, or complemented by, a personal computer (e.g., a notebook, a laptop, a desktop), a smartphone (e.g., device 600), a tablet, an automotive console, a media device, a set-top box, a network-based server hosting a user-accessible client device, a non-user-owned device, any other suitable device, or any combination thereof.

Control circuitry 604 may be based on any suitable control circuitry such as processing circuitry 606. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 604 executes instructions for a voice processing application (e.g., a language model, a virtual assistant, etc.) stored in memory (e.g., storage 608). Control circuitry 604 may be instructed by the voice processing application to perform the functions discussed above and below. In some implementations, processing or actions performed by control circuitry 604 may be based on instructions received from the voice processing application.

In client/server-based embodiments, control circuitry 604 may include communications circuitry suitable for communicating with a server or other networks or servers. The voice processing application may be a stand-alone application implemented on a device or a server. The voice processing application may be implemented as software or a set of executable instructions. The instructions for performing any of the embodiments discussed herein of the voice processing application may be encoded on non-transitory computer-readable media (e.g., a hard drive, random-access memory on a DRAM integrated circuit, read-only memory on a BLU-RAY disk, etc.). For example, in FIG. 6, the instructions may be stored in storage 608, and executed by control circuitry 604 of a device 600.

Control circuitry 604 may include communications circuitry suitable for communicating with a server, edge computing systems and devices, a table or database server, or other networks or servers. The instructions for carrying out the aforementioned functionality may be stored on a server (which is described in more detail in connection with FIG. 7). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 7). In addition, communications circuitry may include circuitry that enables peer-to-peer communication of user equipment devices, or communication of user equipment devices in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of content described herein as well as voice processing application data described above. Nonvolatile memory may also be used (e.g., to launch a boot-up routine and other instructions). Cloud-based storage, described in relation to FIG. 6, may be used to supplement storage 608 or in place of storage 608.

Control circuitry 604 may include video generating circuitry and tuning circuitry, such as one or more analog tuners, one or more MPEG-2 decoders or other digital decoding circuitry, high-definition tuners, or any other suitable tuning or video circuits or combinations of such circuits. In some embodiments, encoding circuitry (e.g., for converting over-the-air, analog, or digital signals to MPEG signals for storage), audio synthesis circuitry, video/image generating circuitry, and other circuitry configured for functions related to voice-based interfaces may also be provided. Control circuitry 604 may also include scaler circuitry for upconverting and downconverting content into the preferred output format of user equipment device 600. Control circuitry 604 may also include digital-to-analog converter circuitry and analog-to-digital converter circuitry for converting between digital and analog signals. The associated circuitry may be used by user equipment device 600, 601 to receive and/or capture user inputs and/or other interactions and to display, to output, to generate, or to play the device outputs including recommended commands based on user preferences. The associated circuitry may also be used to receive voice processing data. The associated circuitry described herein, including for example, the tuning, video/image generating, audio synthesizing, encoding, decoding, encrypting, decrypting, scaler, and analog/digital circuitry, may be implemented using software running on one or more general purpose or specialized processors. Multiple tuners (e.g., in the coordinator device 615) may be provided to handle simultaneous tuning functions (e.g., watch and record functions, picture-in-picture (PIP) functions, multiple-tuner recording, etc.). If storage 608 is provided as a separate device from user equipment device 600, any associated circuitry (including audio synthesis circuitry, multiple tuners, etc.) may be associated with storage 608.

Control circuitry 604 may receive instruction from a user by way of user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of each one of user equipment device 600 and user equipment device 601. For example, display 612 may be a touchscreen or touch-sensitive display. In such circumstances, user input interface 610 may be integrated with or combined with display 612. In some embodiments, user input interface 610 includes a remote-control device having one or more microphones, buttons, keypads, and any other components configured to receive user input or combinations thereof. For example, user input interface 610 may include a handheld remote-control device having an alphanumeric keypad and option buttons. In a further example, user input interface 610 may include a handheld remote-control device having a microphone and control circuitry configured to receive and identify voice commands and transmit information to the coordinator device 615.

Audio output equipment 614 may be integrated with or combined with display 612. Display 612 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 612. Audio output equipment 614 may be provided as integrated with other elements of each one of devices 600 and 601 or may be stand-alone units. An audio component of videos and other content displayed on display 612 may be played through speakers (or headphones) of audio output equipment 614. In some embodiments, audio may be distributed to a receiver, which processes and outputs the audio via speakers of audio output equipment 614. In some embodiments, for example, control circuitry 604 is configured to provide audio cues to a user, or other audio feedback to a user, using speakers of audio output equipment 614. There may be a separate microphone 616 or audio output equipment 614 may include a microphone configured to receive audio input such as voice commands or speech. For example, a user may speak letters or words that are received by the microphone and converted to text by control circuitry 604. In a further example, a user may voice commands that are received by a microphone and recognized by control circuitry 604. Camera 618 may be any suitable video camera integrated with the equipment or externally connected. Camera 618 may be a digital camera comprising a charge-coupled device (CCD) and/or a complementary metal-oxide semiconductor (CMOS) image sensor. Camera 618 may be an analog camera that converts to digital images via a video card.

The voice processing application may be implemented using any suitable architecture. For example, it may be a stand-alone application wholly-implemented on each one of user equipment device 600 and user equipment device 601. In such an approach, instructions of the application may be stored locally (e.g., in storage 608), and data for use by the application is downloaded on a periodic basis (e.g., from an out-of-band feed, from an Internet resource, or using another suitable approach). Control circuitry 604 may retrieve instructions of the application from storage 608 and process the instructions to provide voice processing functionality and perform any of the actions discussed herein. Based on the processed instructions, control circuitry 604 may determine what action to perform when input is received from user input interface 610. For example, movement of a cursor on a display up/down may be indicated by the processed instructions when user input interface 610 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, the voice processing application is a client/server-based application. Data for use by a thick or thin client implemented on each one of user equipment device 600 and user equipment device 601 may be retrieved on-demand by issuing requests to a server remote to each one of user equipment device 600 and user equipment device 601. For example, the remote server may store the instructions for the application in a storage device. The remote server may process the stored instructions using circuitry (e.g., control circuitry 604) and generate the displays discussed above and below. The client device may receive the displays generated by the remote server and may display the content of the displays locally on device 600. This way, the processing of the instructions is performed remotely by the server while the resulting displays (e.g., that may include text, a keyboard, or other visuals) are provided locally on device 600. Device 600 may receive inputs from the user via input interface 610 and transmit those inputs to the remote server for processing and generating the corresponding displays. For example, device 600 may transmit a communication to the remote server indicating that an up/down button was selected via input interface 610. The remote server may process instructions in accordance with that input and generate a display of the application corresponding to the input (e.g., a display that moves a cursor up/down). The generated display is then transmitted to device 600 for presentation to the user.

In some embodiments, the voice processing application may be downloaded and interpreted or otherwise run by an interpreter or virtual machine (run by control circuitry 604). In some embodiments, the voice processing application may be encoded in the ETV Binary Interchange Format (EBIF), received by control circuitry 604 as part of a suitable feed, and interpreted by a user agent running on control circuitry 604. For example, the voice processing application may be an EBIF application. In some embodiments, the voice processing application may be defined by a series of JAVA-based files that are received and run by a local virtual machine or other suitable middleware executed by control circuitry 604.

FIG. 7 is a diagram of an illustrative voice-based interface system 700 for recommending a voice command, in accordance with some embodiments of this disclosure. User equipment 720 (e.g., a smart hub device, a virtual assistant device, a voice input control, a smartphone, an extended reality wearable device, a smart television) may be coupled to a communication network 710. The communication network 710 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 710) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the coupled devices may be provided by one or more of these communications paths but are shown as a single path in FIG. 7 to avoid overcomplicating the drawing.

Although communications paths are not drawn between individual devices of the user equipment 720, these devices may communicate directly with each other via communications paths as well as other short-range, point-to-point communications paths, such as USB cables, IEEE 1394 cables, wireless paths (e.g., Bluetooth, infrared, IEEE 802-11x, etc.), or other short-range communication via wired or wireless paths. The devices of the user equipment 720 may also communicate with each other directly through an indirect path via communication network 710.

System 700 may comprise one or more servers 730 including edge servers or edge computing devices as part of an edge computing system (not shown). The one or more servers 730 including any component of an edge computing system (not shown) may be configured to be in communication with any device of the user equipment 720 over communication network 710. The one or more servers 730 including any component of the edge computing system (not shown) may be configured to perform processing tasks (e.g., natural language processing, voice processing, etc.) in connection with ongoing processing of voice interface data. In some embodiments, a plurality of edge servers and/or edge computing devices of the edge computing system (not shown) may be strategically located at various geographic locations and may include mobile edge computing devices configured to provide processing support for mobile devices at various geographical regions. In some embodiments, the voice processing application may be executed at one or more of control circuitry 731 of server 730, and/or control circuitry of one or more of the devices of the user equipment 720. In some embodiments, data may be stored at database 734 maintained at or otherwise associated with server 730, and/or at storage of one or more of the devices of the user equipment 720.

In some embodiments, the server 730 may include control circuitry 731 and storage 733 (e.g., RAM, ROM, Hard Disk, Removable Disk, etc.). Storage 733 may store one or more databases. Server 730 may also include an input/output path 732. I/O path 732 may provide voice processing data, device information, or other data, over a local area network (LAN) or wide area network (WAN), and/or other content and data to control circuitry 731, which may include processing circuitry, and storage 733. Control circuitry 731 may be used to send and receive commands, requests, and other suitable data using I/O path 732, which may comprise I/O circuitry. I/O path 732 may connect control circuitry 731 to one or more communications paths.

Control circuitry 731 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 731 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 731 executes instructions for an emulation system application stored in memory (e.g., the storage 733). Memory may be an electronic storage device provided as storage 733 that is part of control circuitry 731.

In some embodiments, the voice processing application may be a client/server application where only the client application resides on device 600, and a server application resides on an external server (e.g., server 730). For example, the voice processing application may be implemented partially as a client application on control circuitry 604 of device 600 and partially on server 730 as a server application running on control circuitry 731. Server 730 may be a part of a local area network with one or more of devices 600 or may be part of a cloud computing environment accessed via the internet. In a cloud computing environment, various types of computing services for performing searches on the internet or informational databases, providing voice processing capabilities, providing storage (e.g., for a database) or parsing data (e.g., using machine learning algorithms described above and below) are provided by a collection of network-accessible computing and storage resources (e.g., server 730), referred to as “the cloud.” Device 600 may be a cloud client that relies on the cloud computing capabilities from server 730 to determine whether processing (e.g., at least a portion of virtual background processing and/or at least a portion of other processing tasks) should be offloaded from a mobile device and facilitate such offloading. When executed by control circuitry of server 730, the voice processing application may instruct control circuitry 731 to perform processing tasks for a client device and facilitate the voice processing.

In one or more embodiments discussed in preceding paragraphs and the following paragraphs related to processes 800-1000, the individual blocks of the processes 800-1000 may be implemented by one or more components of the devices and/or systems of FIGS. 1-7. It is noted that the present disclosure may describe one or more blocks of processes 800-1000 as being implemented by specific components of the devices and/or systems of FIGS. 1-7 for illustrative purposes. It is contemplated that one or more blocks of the discussed processes herein may be implemented by other components of the devices and/or systems or other devices and/or systems. For example, while control circuitry may be described in the following paragraphs, various blocks may be implemented at display circuitry, communication circuitry, processing circuitry, and/or other types of circuitries.

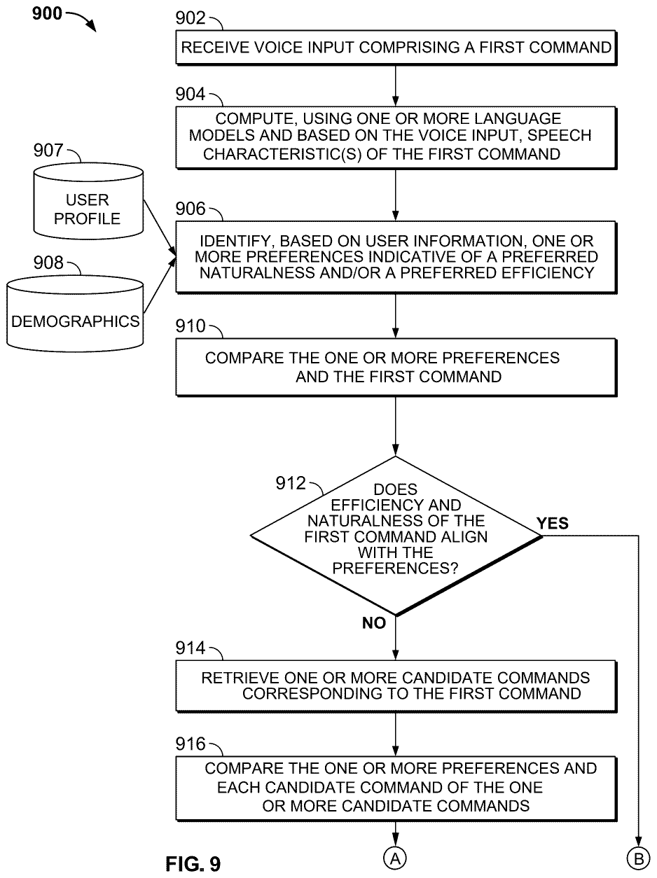

FIG. 8 is a flowchart of a detailed illustrative process 800 for generating a command recommendation based on user preferences, in accordance with some embodiments of this disclosure. At block 802, control circuitry receives a voice-based command. The voice-based command may indicate a device action to be executed. For example, control circuitry 604 may receive a voice input comprising a first command. The control circuitry 604 may process the voice input, generate text corresponding to the voice input, parse the text, and identify the first command based on the text. At block 804, control circuitry determines whether the voice-based command matches user preferences 805. For example, control circuitry 604 of FIG. 6 may access the user preferences 805, identify one or more preferred speech characteristics, and compare the first command to the preferred speech characteristics. If the first command aligns with the preferred speech characteristics (“Yes”), the control circuitry continues to execute the command at block 812. If the first command does not align with one or more of the preferred speech characteristics (“No”), the control circuitry continues to block 806.

At block 806, the control circuitry determines whether there is an alternate command in a command list 807 based on the first command. For example, the control circuitry 604 may access the command list 807. In some embodiments, the command list 807 may be stored in local memory or stored remotely at the database 734 of FIG. 7 and accessible through the network 710 of FIG. 7. If the control circuitry 604 does not identify an alternate command (“No”), the control circuitry 604 executes the command at block 812. If the control circuitry 604 determines the command list 807 includes command(s) based on the first command (“Yes”), the control circuitry 604 identifies, based on the command list 807, an alternate command corresponding to the first command.

At block 808, control circuitry determines whether usage of the alternate command would be beneficial based on user interaction history 809. For example, the control circuitry 604 may retrieve previous vocal or other user inputs from the user interaction history 809. The control circuitry 604 may determine that the first command is frequently used and that the alternate command is more efficient and/or easier to speak (e.g., fewer syllables, lower pronunciation complexity). Based on determining a predicted benefit of the alternate command, the control circuitry 604 may recommend the alternate command.

At block 810, control circuitry generates for output a response for the received voice-based command. The response may comprise a voice component. For example, the control circuitry 604 may generate synthesized speech audio as part of the response. The response comprises a command recommendation indicating the alternate command. At block 812, control circuitry executes the command, e.g., by causing a target device to perform the device action.

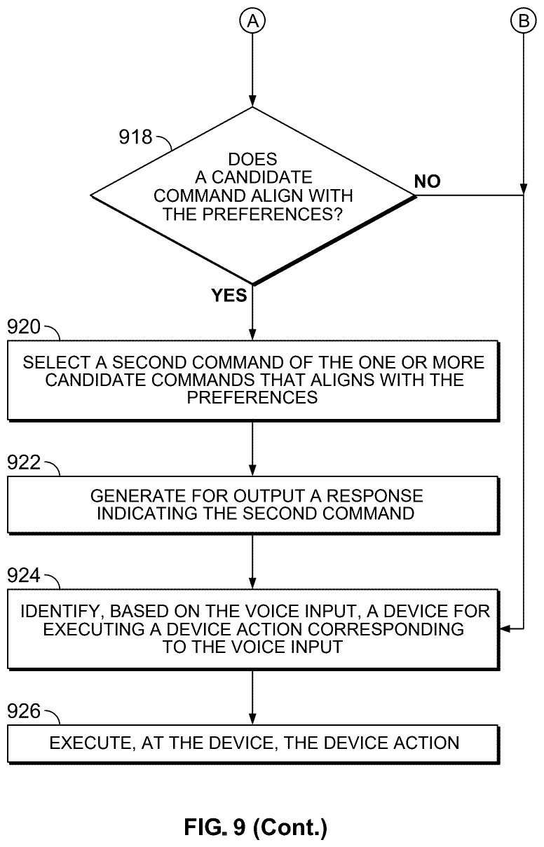

FIG. 9 is a flowchart of a detailed illustrative process 900 including recommending a command that aligns with user preferences, in accordance with some embodiments of this disclosure. At block 902, control circuitry receives a voice input comprising a first command. For example, processing circuitry 606 may receive the voice input via microphone 616 of FIG. 6 or via a network-connected device. At block 904, control circuitry determines speech characteristics of the first command. For example, the processing circuitry 606 computes, using one or more language models and based on the voice input, one or more speech characteristics (e.g., a speech efficiency and/or a speech naturalness) of the first command. At block 906, control circuitry identifies one or more preferences indicative of one or more preferred speech characteristics. For example, the processing circuitry 606 may access user information comprising a user profile 907 and/or demographic information 908. The processing circuitry 606 identifies, based on the user information, preferred speech characteristics indicative of a preferred speech naturalness and/or preferred speech efficiency. For example, the processing circuitry 606 may identify a job from the user profile and determine that the demographic information indicates users with the same or a similar job are likely to prefer a conversational style (e.g., a high speech naturalness).

At block 910, control circuitry compares the preferences and the first command. For example, the processing circuitry 606 may compare the preferences and the first command using one or more language models. At block 912, control circuitry determines whether the first command aligns with the preferences. If the first command aligns with the preferences (“Yes”), control circuitry may continue to block 924. If the first command does not align with the preferences (“No”), control circuitry continues to block 914. For example, the processing circuitry 606 may determine that the first command does not align with the speech naturalness, such as not following the conversational style. For example, the processing circuitry 606 may use a language evaluation model for determining that the first command does not follow the conversational style. The model may have been trained to determine if an input sentence follows a conversational structure based on NLU-based analytics and/or based on a reference sentence.

At block 914, control circuitry retrieves one or more candidate commands corresponding to the first command. For example, the processing circuitry 606 may determine a device action indicated by the first command and identify the candidate commands that correspond to the device action. At block 916, control circuitry compares the preferences and each candidate command of the one or more candidate commands. For example, processing circuitry 606 may compare the preferences and the candidate commands in an analogous manner as described at block 910. At block 918, control circuitry determines whether there is a candidate command that aligns with the preferences. If there is no candidate command that aligns with the preferences (“No”), the control circuitry may continue to block 924. If there is a suitable candidate command (“Yes”), then control circuitry continues to block 920. At block 920, control circuitry selects a second command of the one or more candidate commands that aligns with the preferences. At block 922, control circuitry generates for output a response indicating the second command. At block 924, control circuitry identifies a device for executing a device action corresponding to the voice input. For example, the voice input may indicate a target device, and processing circuitry 606 may identify the target device. At block 926, control circuitry causes to be executed the device action at the identified device. For example, the processing circuitry 606 may transmit an instruction to the target device, and based at least in part on the instruction, causes the target device to perform the device action.

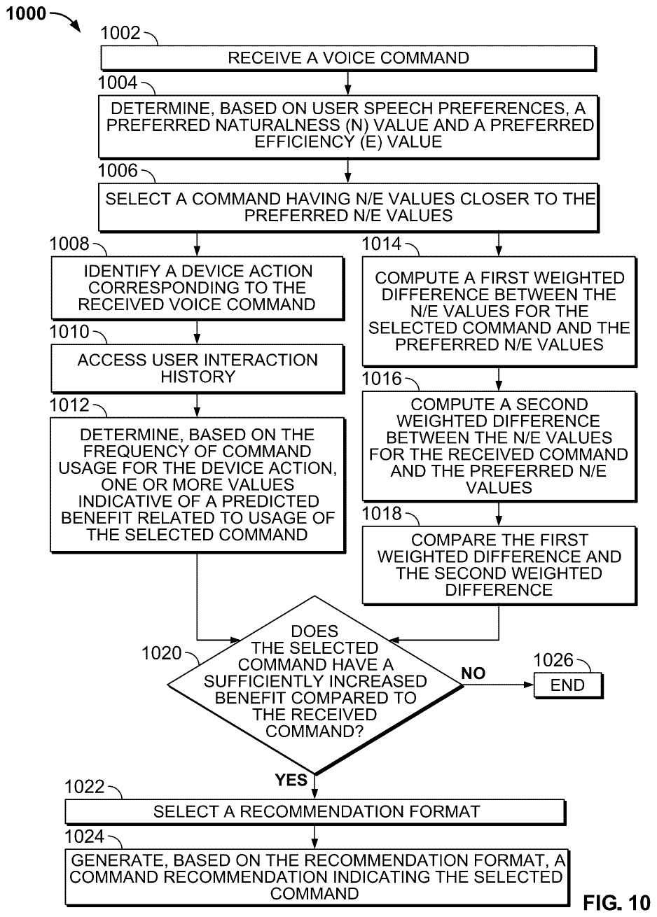

FIG. 10 is a flowchart of a detailed illustrative process 1000 including determining a recommendation format for providing a command that aligns with user preferences, in accordance with some embodiments of this disclosure. At block 1002, control circuitry receives a voice command. At block 1004, control circuitry determines values indicating preferred speech characteristics such as a preferred speech naturalness score and/or a preferred speech efficiency score. At block 1006, control circuitry selects an alternate command having speech characteristic values that are closer to the preferred speech characteristic values. For example, control circuitry 731 of FIG. 7 may select an alternate command having a speech naturalness score and/or a speech efficiency score closer to the preferred scores. At block 1008, control circuitry identifies a device action corresponding to the voice command. At block 1010, control circuitry accesses a user interaction history. At block 1012, control circuitry determines, based on frequency of command usage for the device action, values indicative of a predicted benefit related to using the selected command. The control circuitry may determine if the predicted benefit has a sufficient improvement, for example, based on weighted differences in the speech characteristic values.

At block 1014, control circuitry computes a first weighted difference between the speech characteristic values for the selected command and the preferred speech characteristic values. At block 1016, control circuitry computes a second weighted difference between the speech characteristic values for the received command and the preferred speech characteristic values. At block 1018, control circuitry compares the weighted differences for determining if a predicted benefit meets or exceeds a benefit threshold. For example, control circuitry may determine a weighted combined score based on the speech naturalness and/or the speech efficiency and calculate the change (increase or decrease) in the weighted combined score. At block 1020, control circuitry determines whether the selected command has a sufficient predicted benefit. For example, the control circuitry may determine the weighted combined score for the selected command is greater than the scores for the received command. In some embodiments, control circuitry may determine whether the increased combined score meets or exceeds a minimum improvement threshold. If the increased score is not sufficient (“No”), control circuitry does not recommend the selected command and continues to 1026, where the process 1000 ends. If the increased score is sufficient (“Yes”), control circuitry, at block 1022, selects a recommendation format (e.g., an explicit statement, an implicit suggestion). At block 1024, control circuitry generates, based on the recommendation format, a command recommendation indicating the selected command. In some embodiments, one or more of blocks 1014-1018 may be performed prior to or subsequent to one or more of blocks 1008-1012. Additionally, or alternatively, one or more of blocks 1008-1012 and one or more of blocks 1014-1018 may be performed in parallel (e.g., concurrently, simultaneously, etc.).

The processes discussed above are intended to be illustrative and not limiting. One skilled in the art would appreciate that the steps of the processes discussed herein may be omitted, modified, combined and/or rearranged, and any additional steps may be performed without departing from the scope of the present disclosure. More generally, the above disclosure is meant to be illustrative and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving a voice input comprising a first command;
computing, using one or more language models and based at least in part on the voice input, one or more speech characteristics of the first command indicative of a speech efficiency and a speech naturalness;
identifying, based on user information, one or more user preferences indicative of a preferred speech naturalness and a preferred speech efficiency;
comparing the one or more user preferences and the one or more speech characteristics of the first command;
determining, based on the comparing the one or more user preferences and the one or more speech characteristics of the first command, that the one or more speech characteristics do not align with the one or more user preferences indicative of one or both of the preferred speech naturalness and the preferred speech efficiency;
based at least in part on the determining, retrieving one or more candidate commands corresponding to the first command;
comparing the one or more user preferences and one or more speech characteristics of each candidate command of the one or more candidate commands;
selecting, based on the comparing the one or more user preferences and the one or more candidate commands, a second command of the one or more candidate commands that aligns with the one or more user preferences indicative of one or both of the preferred speech naturalness and the preferred speech efficiency; and
generating for output a response corresponding to the voice input, the response indicating the second command.

2. The method of claim 1, further comprising:
identifying, based at least in part on the voice input, a device for executing a device action corresponding to the first command; and
causing to be executed, at the device, the device action.

3. The method of claim 1, wherein computing the one or more speech characteristics of the first command indicative of the speech efficiency and the speech naturalness comprises:
computing an efficiency score corresponding to the speech efficiency of the first command; and
computing a naturalness score corresponding to the speech naturalness of the first command.

4. The method of claim 3, wherein the efficiency score indicates a predicted amount of time for speaking the first command, and wherein the naturalness score indicates a similarity between the first command and a natural language structure.

5. The method of claim 4, further comprising:
identifying a number of phonemes in the first command;
determining, based at least in part on the voice input, an amount of time to speak the first command; and
computing a speech rate of the number of phonemes to the amount of time to speak the first command, wherein the efficiency score is computed based at least in part on the speech rate.

6. The method of claim 4, further comprising:
generating, based on the first command, a speech-to-text transcription corresponding to the first command;
accessing a first language model of the one or more language models, wherein the first language model is trained to determine a similarity between an input and the natural language structure; and
determining, using the first language model, a similarity value between the speech-to-text transcription corresponding to the first command and the natural language structure, wherein the naturalness score is computed based at least in part on the similarity value.

7. The method of claim 3, wherein determining that the one or more speech characteristics of the first command do not align with the one or more user preferences indicative of one or both of the preferred speech naturalness and the preferred speech efficiency comprises:
determining, based on the one or more user preferences, a preferred naturalness score corresponding to the preferred speech naturalness and a preferred efficiency score corresponding to the preferred speech efficiency;
based at least in part on determining that the efficiency score is outside a first threshold from the preferred efficiency score, determining that the one or more speech characteristics do not align with the one or more user preferences indicative of the preferred speech efficiency; and
based at least in part on determining that the naturalness score is outside a second threshold from the preferred naturalness score, determining that the one or more speech characteristics do not align with the one or more user preferences indicative of the preferred speech naturalness.

8. The method of claim 1, further comprising:
identifying, based on the user information, a user demographic;
accessing demographic information; and
determining, based at least in part on the demographic information, the one or more user preferences indicative of one or both of the preferred speech naturalness and the preferred speech efficiency corresponding to the user demographic.

9. The method of claim 1, wherein the user information comprises a user profile, the method further comprising:
accessing, from the user profile, a user interaction history comprising one or more previous voice inputs;
determining, using the one or more language models, one or more scores based on the previous voice inputs; and
determining, based at least in part on the one or more scores, the one or more user preferences indicative of one or both of the preferred speech efficiency and the preferred speech naturalness.

10. The method of claim 9, wherein the one or more previous voice inputs comprise a first previous voice input, and wherein the determining the one or more scores based on the previous voice inputs comprises:
retrieving a naturalness score and an efficiency score corresponding to the first previous voice input;
determining, based on the user interaction history and the first previous voice input, at least one of a usage frequency or a recency of usage and corresponding weights; and
computing, based on the corresponding weights, the naturalness score, and the efficiency score, a weighted naturalness score and a weighted efficiency score.

11. A system comprising:
a user interface configured to receive a voice input comprising a first command; and
control circuitry configured to:
compute, using one or more language models and based at least in part on the voice input, one or more speech characteristics of the first command indicative of a speech efficiency and a speech naturalness;
identify, based on user information, one or more user preferences indicative of a preferred speech naturalness and a preferred speech efficiency;
compare the one or more user preferences and the one or more speech characteristics of the first command;
determine, based on comparing the one or more user preferences and the one or more speech characteristics of the first command, that the one or more speech characteristics do not align with the one or more user preferences indicative of one or both of the preferred speech naturalness and the preferred speech efficiency;
based at least in part on determining that the one or more speech characteristics do not align with the one or more user preferences, retrieve one or more candidate commands corresponding to the first command;
compare the one or more user preferences and one or more speech characteristics of each candidate command of the one or more candidate commands;
select, based on the comparing the one or more user preferences and the one or more candidate commands, a second command of the one or more candidate commands that aligns with the one or more user preferences indicative of one or both of the preferred speech naturalness and the preferred speech efficiency; and
generate for output a response corresponding to the voice input, the response indicating the second command.

12. The system of claim 11, wherein the control circuitry is further configured to:
identify, based at least in part on the voice input, a device for executing a device action corresponding to the first command; and
cause to be executed, at the device, the device action.

13. The system of claim 11, wherein the control circuitry, when computing the one or more speech characteristics of the first command indicative of the speech efficiency and the speech naturalness, is configured to:
compute an efficiency score corresponding to the speech efficiency of the first command; and
compute a naturalness score corresponding to the speech naturalness of the first command.

14. The system of claim 13, wherein the efficiency score indicates a predicted amount of time for speaking the first command, and the naturalness score indicates a similarity between the first command and a natural language structure.

15. The system of claim 14, wherein the control circuitry is further configured to:
identify a number of phonemes in the first command;
determine, based at least in part on the voice input, an amount of time to speak the first command; and
compute a speech rate of the number of phonemes to the amount of time to speak the first command, wherein the efficiency score is computed based at least in part on the speech rate.

16. The system of claim 14, wherein the control circuitry is further configured to:
generate, based on the first command, a speech-to-text transcription corresponding to the first command;
access a first language model of the one or more language models, wherein the first language model is trained to determine a similarity between an input and the natural language structure; and
determine, using the first language model, a similarity value between the speech-to-text transcription corresponding to the first command and the natural language structure, wherein the naturalness score is computed based at least in part on the similarity value.

17. The system of claim 13, wherein the control circuitry, when determining that the one or more speech characteristics of the first command do not align with the one or more user preferences indicative of one or both of the preferred speech naturalness and the preferred speech efficiency, is configured to:
determine, based on the one or more user preferences, a preferred naturalness score corresponding to the preferred speech naturalness and a preferred efficiency score corresponding to the preferred speech efficiency;
based at least in part on determining that the efficiency score is outside a first threshold from the preferred efficiency score, determine that the one or more speech characteristics do not align with the one or more user preferences indicative of the preferred speech efficiency; and
based at least in part on determining that the naturalness score is outside a second threshold from the preferred naturalness score, determine that the one or more speech characteristics do not align with the one or more user preferences indicative of the preferred speech naturalness.

18. The system of claim 11, wherein the control circuitry is further configured to:
identify, based on the user information, a user demographic;
access demographic information; and
determine, based at least in part on the demographic information, the one or more user preferences indicative of one or both of the preferred speech naturalness and the preferred speech efficiency corresponding to the user demographic.

19. The system of claim 11, wherein the user information comprises a user profile, and wherein the control circuitry is further configured to:
access, from the user profile, a user interaction history comprising one or more previous voice inputs;
determine, using the one or more language models, one or more scores based on the previous voice inputs; and
determine, based at least in part on the one or more scores, the one or more user preferences indicative of one or both of the preferred speech efficiency and the preferred speech naturalness.

20. The system of claim 19, wherein the one or more previous voice inputs comprise a first previous voice input, and wherein the control circuitry, when determining the one or more scores based on the previous voice inputs, is configured to:
retrieve a naturalness score and an efficiency score corresponding to the first previous voice input;
determine, based on the user interaction history and the first previous voice input, at least one of a usage frequency or a recency of usage and corresponding weights; and
compute, based on the corresponding weights, the naturalness score, and the efficiency score, a weighted naturalness score and a weighted efficiency score.

21-50. (canceled)
